(19) United States
(12) Patent Application Publication
(10) Pub. No.: US 2024/0408908 A1
(43) Pub. Date: Dec. 12, 2024

(54) PRINTING METHOD, PRINTING SYSTEM, AND PRINTING DEVICE

(71) Applicant: MIMAKI ENGINEERING CO., LTD., Nagano (JP)

(72) Inventors: Nobuyasu Usui, Nagano (JP); Tomohiko Takizawa, Nagano (JP)

(73) Assignee: MIMAKI ENGINEERING CO., LTD., Nagano (JP)

(21) Appl. No.: 18/718,786

(22) PCT Filed: Dec. 8, 2022
(86) PCT No.: PCT/JP2022/045343

§ 371 Date: Jun. 11, 2024

(30) Foreign Application Priority Data
Dec. 13, 2021 (JP) 2021-201719

(51) Int. Cl. B41M 5/035; B41J 2/01; B41J 2/21; B41M 1/20

(52) U.S. Cl. CPC B41M 5/0356; B41J 2/21; B41M 1/20; B41J 2002/012

(57) ABSTRACT

A printing method for drawing an image on a transfer-receiving medium by transferring the image printed on a transfer medium to the transfer-receiving medium, the method including: a printing stage of printing the image on the transfer medium with a printing unit, which is a printing device; a hot melt resin adhering stage of causing hot melt resin powder to adhere to the transfer medium; and a transfer stage of transferring the image from the transfer medium to the transfer-receiving medium, in which the printing unit includes a colored ink head that ejects a colored ink and a clear ink head that ejects a clear ink, and in the printing stage, the clear ink is further ejected from the clear ink head to at least a part of a region to which the colored ink is ejected from the colored ink head in the transfer medium.

### CROSS-REFERENCE TO RELATED APPLICATION

This application is a 371 application of the International PCT application serial no. PCT/JP2022/045343 filed on Dec. 8, 2022, which claims the priority benefit of Japan Patent Application No. JP 2021-201719 filed on Dec. 13, 2021. The entirety of each of the above-mentioned patent applications is hereby incorporated by reference herein and made a part of this specification.

### BACKGROUND

### Technical Field

This disclosure relates to a printing method, a printing system, and a printing device.

### Background Art

Conventionally, there is known a method of performing transfer printing by using a hot melt layer formed of resin powder. In this method, for example, an image is printed on a transfer medium (a transfer sheet or the like) having a surface on which a release layer is formed, and the transfer medium and a transfer-receiving medium are superimposed on each other, and heated and pressurized in a state where the hot melt layer is further formed on the entire surface of the transfer medium to transfer the image from the transfer medium to the transfer-receiving medium. In this case, for example, a film or the like on which a receiving layer is formed is used as the transfer medium, and the image is printed on the transfer medium by using color inks. On that image, an ink colored in white (a white ink) is used to form a white ink layer. Then, hot melt resin powder (fine particles) is caused to adhere onto the white ink layer in the transfer medium, and press-bonded by a heat press machine to transfer the image. Further, conventionally, there is also known a method of forming the hot melt layer in accordance with the image without forming the hot melt layer on the entire surface of the transfer medium (for example, Patent Literature 1).

### CITATION LIST

### Patent Literature

Patent Literature 1: Japanese Unexamined Patent Publication No. 2019-171840

### SUMMARY OF DISCLOSURE

### Technical Problems

In a case where the white ink layer is formed on the image printed with the color inks, the image can be appropriately represented on the transfer-receiving medium even if a base color of the transfer-receiving medium is a dark color. However, in this case, the white ink layer to be formed in a range larger than the image is also transferred to the transfer-receiving medium. Therefore, unnecessary portions of the original image, such as margins or the like, may be transferred, which may impair a design and a texture of the transfer-receiving medium. On the other hand, for example, as in a method disclosed in Patent Literature 1, if the hot melt layer is formed in accordance with the image, only a part necessary for representing the image can be transferred from the transfer medium to the transfer-receiving medium. Further, in this case, by using a fabric or the like with a light (bright) base color such as white or beige as the transfer-receiving medium, the design and the texture of the transfer-receiving medium can be improved by utilizing the base color or a material of the transfer-receiving medium, and the like.

However, in the method disclosed in Patent Literature 1, as the transfer medium, a transfer sheet is used that is non-water-repellent and maintains enough ink impermeability to retain adhesiveness of the powder until the image is formed and the powder is sprinkled. Further, as the powder, resin powder of a predetermined grade having a small particle diameter is used. However, in this case, it can be considered that cost of printing greatly increases and flexibility of printing conditions greatly decreases due to limitation of conditions of available transfer mediums and powder.

Further, the inventors of this application have actually conducted various experiments and the like, and found that when the image is transferred without using the white ink layer, quality of the image transferred to the transfer-receiving medium may be deteriorated. Therefore, it is desired to transfer the image by a more appropriate method. Therefore, this disclosure aims to provide a printing method, a printing system, and a printing device that can solve the above problems.

### SUMMARY

The inventors of this application have conducted intensive research on image transfer by a more appropriate method, and for example, a method of transferring the image more appropriately without forming the white ink layer, even in a case of using a common color ink and transfer medium for the transfer. Further, in this intensive research, it has been found that, in a case where the white ink layer is not formed, transferability is deteriorated in a low gradation region for expressing the light color in the image as compared with a high gradation region for expressing a darker color, and unintended transfer unevenness occurs. Further, as for a cause of the problem, it has been also found that, due to a decrease in an amount of each of the color inks in the low gradation region, an amount of the hot melt resin adhering to that part decreases, and the image cannot be completely transferred. In this case, the transferability of the image is deteriorated in that part, and thus, for example, on the transfer-receiving medium, uncolored parts are scattered throughout portions that should normally be colored. As a result, for example, the transfer unevenness occurs.

On the other hand, the inventors of this application have considered further use of a clear ink that hardly affects the colors of the image in addition to the color inks. In a case of such configuration, for example, an adhesion amount of the hot melt resin can be appropriately prevented from becoming insufficient by further ejecting the clear ink to the transfer medium in the low gradation region of the image in which the amounts of the color inks used decrease. Accordingly, for example, it is possible to appropriately prevent the quality of the image after the transfer from deteriorating due to the occurrence of transfer unevenness and the like.

Further, the inventors of this application have found characteristics necessary for obtaining such effects through further intensive research, and have achieved this disclosure. In order to solve the above problems, this disclosure is a printing method for drawing an image on a transfer-receiving medium by transferring the image printed on a transfer medium to the transfer-receiving medium, the printing method including: a printing stage of printing the image on the transfer medium with a printing device that performs printing through an inkjet method; a hot melt resin adhering stage of causing hot melt resin powder, which is powder containing a resin softened through heating, to adhere to the transfer medium on which the image is printed; and a transfer stage of transferring the image from the transfer medium to the transfer-receiving medium by causing a hot melt resin portion to adhere to the transfer-receiving medium, the hot melt resin portion being a resin portion formed by heating the transfer medium to which the hot melt resin powder adheres, and softening the hot melt resin powder through heating, in which the printing device includes: a colored ink head that is an inkjet head ejecting a colored ink, which is an ink containing a coloring material showing a nonwhite color, and a clear ink head that is an inkjet head ejecting a clear ink, which is a colorless and translucent ink, and in the transfer medium, the clear ink is further ejected from the clear ink head to at least a part of a region to which the colored ink is ejected from the colored ink head in the printing stage.

In a case of such configuration, by using the clear ink in addition to the colored ink during the printing on the transfer medium with the printing device, for example, it is possible to appropriately eject the ink other than the colored ink to the transfer medium while appropriately suppressing influence of the colors of the image to be printed on the transfer medium. Accordingly, for example, a total amount of the inks ejected to the transfer medium can be increased by ejecting the clear ink to a position where an ejection amount of the colored ink decreases as compared with a case of using only the colored ink. Further, in this case, for example, it is possible to cause the hot melt resin powder to adhere more appropriately to the transfer medium by increasing the total amount of the inks. Accordingly, for example, during the transfer of the image from the transfer medium to the transfer-receiving medium, it is possible to appropriately prevent the occurrence of the transfer unevenness and the like due to insufficient hot melt resin powder. Therefore, according to such configuration, for example, the image transfer performed by using the hot melt resin powder can be more appropriately performed.

In this configuration, in the printing stage, for example, the printing on the transfer medium is performed by using the colored ink and the clear ink without using the white ink. Further, in this configuration, for example, a known transfer film can be suitably used as the transfer medium. As the known transfer film, for example, a transfer film for transfer by a direct to film (DTF) method can be suitably used. Further, as the transfer medium, a medium other than the film (for example, a paper medium) may be used. As the transfer-receiving medium, for example, a cloth medium can be suitably used. As the colored ink, for example, known color inks (for example, a known ink for textile printing) can be suitably used. As the known color inks, for example, an ink containing a pigment as the coloring material (for example, an aqueous pigment ink) can be suitably used.

In the transfer stage, for example, the image is transferred from the transfer medium to the transfer-receiving medium by moving at least a part of the coloring material adhering to the transfer medium to the transfer-receiving medium together with at least a part of the hot melt resin portion. In this case, for example, it can be considered to increase a transfer rate of the coloring material by using the clear ink. More specifically, for example, in a case where a region to which the colored ink is ejected from the colored ink head in the transfer medium is defined as an image representing region, a region to which the amount of the colored ink ejected per unit area is less than a preset reference amount is defined as a small amount of ink region, and a ratio of the coloring material moving from the transfer medium to the transfer-receiving medium in the transfer stage is defined as a transfer rate, it can be considered that the transfer rate in at least a part of the small amount of ink region is increased by ejecting the clear ink on at least the part of the small amount of ink region in the image representing region with the printing device in the printing stage as compared with a case where the clear ink is not ejected. According to such configuration, for example, it is possible to appropriately prevent the occurrence of the transfer unevenness and the like, and appropriately transfer the image. Further, in this case, for example, it can be considered that the region representing a color of the low gradation region in the image may become the small amount of ink region. Further, in this case, focusing on the small amount of ink region, for example, it can be considered that the amount of the hot melt resin powder adhering to the position to which the clear ink is ejected in the hot melt resin adhering stage by ejecting the clear ink to at least the part of the small amount of ink region in the printing stage is larger than the case where the clear ink is not ejected. According to such configuration, for example, the transfer rate in the small amount of ink region can be appropriately increased. Accordingly, for example, the occurrence of the transfer unevenness and the like can be appropriately prevented.

Further, in this configuration, a sufficient amount of the hot melt resin powder can adhere to a portion where the amount of the colored ink to be ejected is sufficiently large without using the clear ink. Therefore, the ejection amount of the clear ink to each position on the transfer medium may be differed according to, for example, the ejection amount of the colored ink to each position. More specifically, for example, in a case where a region to which the amount of the colored ink ejected per unit area is larger than a predetermined amount, which is larger than the reference amount in the image representing region is defined as a non-small amount of ink region, and the amount of the clear ink per unit area ejected to each position on the transfer medium is defined as a clear ejection amount, it can be considered to differ the clear ejection amount according to the amount of the colored ink ejected per unit area, to make the clear ejection amount in the small amount of ink region larger than the clear ejection amount in the non-small amount of ink region in the printing stage. According to such configuration, for example, it is possible to appropriately eject the clear ink to a necessary portion while suppressing the amount of the clear ink used. Further, in this case, for example, the total amount of the inks ejected to the same position can be prevented from excessively increasing by reducing the clear ejection amount in the non-small amount of ink region.

Further, in a case where the total amount of the inks ejected to the same position increases, for example, it can also be considered that a problem such as smearing of the colored ink tends to occur. Therefore, it can also be considered to set the clear ejection amount to zero, and the like for a portion where the amount of the colored ink to be ejected is large. More specifically, in this case, for example, the clear ink is not ejected to a position where the amount of the colored ink ejected per unit area is larger than a preset upper limit amount in the printing stage. According to such configuration, for example, the total amount of the inks ejected to the same position can be more appropriately prevented from excessively increasing.

Further, in this configuration, the printing device ejects the colored ink and the clear ink from the colored ink head and the clear ink head to ejection positions set according to a resolution of the printing, for example. Then, in this case, for example, it can be considered to eject the clear ink to continuously cover a region including a plurality of the ejection positions with the colored ink and the clear ink. More specifically, in a case where ejection positions to which the colored ink is ejected from the colored ink head are defined as colored ejection positions, and colored ejection positions where adjacent ejection positions are not the colored ejection positions are defined as isolated ejection positions, the small amount of ink region can be considered as, for example, a region including the isolated ejection positions. Then, in the printing stage, for example, by ejecting the clear ink from the clear ink head to at least some of the isolated ejection positions in the small amount of ink region or the ejection positions around the isolated ejection positions, the printing is performed on the transfer medium to connect the ranges including the plurality of the ejection positions including the isolated ejection positions by the colored ink and the clear ink at least near the isolated ejection positions. According to such configuration, for example, the total amount of the inks ejected near the isolated ejection positions in the small amount of ink region can be appropriately increased as compared with a case where the clear ink is not used. Accordingly, for example, the hot melt resin powder can be caused to more appropriately adhere near the isolated ejection positions.

Further, in this configuration, for example, it can be considered to use a medium on which an ink-receiving layer that absorbs the ink is formed as the transfer medium. According to such configuration, for example, occurrence of the smearing of the colored ink can be appropriately prevented. Further, in this case, for example, the printing device is preferably caused to perform the printing to impact the colored ink before the clear ink at each position on the transfer medium in the printing stage. According to such configuration, for example, the occurrence of the smearing can be more appropriately prevented. Further, in this configuration, for example, it can also be considered to lighten graininess, and the like by using the clear ink. More specifically, as each of the colored ink and the clear ink, for example, it can be considered to use an ink that contains a solvent and fixes to the transfer medium by evaporation of the solvent. Then, with respect to a size of an ink dot formed by the colored ink impacted spreading on the transfer medium, in a case where size of dots formed when both the colored ink and the clear ink are ejected to the same ejection positions are defined as clear use sizes, and sizes of dots formed when only the colored ink is ejected to the ejection positions are defined as clear non-use sizes, for example, it can be considered to eject the clear ink to at least some of the ejection positions to which the colored ink is ejected in the small amount of ink region to make the clear use size larger than the clear non-use size in the printing stage. According to such configuration, for example, the size of the ink dot formed with the colored ink can be appropriately spread. Accordingly, for example, the graininess can be appropriately lightened.

Further, in this configuration, for example, an ink containing a binder resin, which is a resin that fixes to the transfer medium together with the coloring material, can be suitably used as the colored ink. Further, in this case, for example, it can be considered to use an ink containing the same resin as the binder resin as the clear ink. According to such configuration, for example, it is possible to appropriately use the clear ink having close characteristics to those of the colored ink. Further, in this case, it can be considered as a state where the hot melt resin powder is likely to continuously adhere to the ink containing the same resin as the binder resin for a long time as compared with, for example, an ink containing no resin. Therefore, by using the clear ink containing the resin, for example, the hot melt resin powder can more reliably adhere to the position to which the clear ink is ejected. Further, as the clear ink, for example, it can also be considered to use an ink that does not contain the same resin as the binder resin in the colored ink. Even in a case of such configuration, by using the clear ink, for example, it is possible to lengthen time until the ink dries to a state where the hot melt resin powder is less likely to adhere to the position to which the clear ink is ejected. Accordingly, for example, even in a case of using the clear ink containing no resin, for example, the hot melt resin powder can appropriately adhere to the position to which the clear ink is ejected.

Further, as for clear ink dot formed on the transfer medium by ejecting the clear ink to the transfer medium, for example, it can also be considered that the ink dot is preferably flattened and spread to make the hot melt resin powder more easily adhere. Then, in this case, for example, it can also be considered to further perform an operation of an adjustment stage of adjusting spread of the clear ink dot formed on the transfer medium in the printing stage. According to such configuration, for example, the size of the clear ink dot can be appropriately adjusted. Further, in this case, for example, it is determined whether or not the spread of the clear ink dot is insufficient based on a result of printing the image on the transfer medium with the printing device under a preset first printing condition in the adjustment stage. Then, for example, in a case where it is determined that the spread of the dot is insufficient, a second printing condition, which is a condition different from the first printing condition and in which the spread of the clear ink dot becomes larger, is selected as a printing condition for causing the printing device to perform the printing in the printing stage. According to such configuration, for example, it is possible to cause the hot melt resin powder to more appropriately adhere to the position to which the clear ink is ejected.

Further, as a configuration of this disclosure, it can also be considered to use a printing system, a printing device, or the like having similar characteristics to those described above. Also in these cases, for example, similar effects as described above can be obtained.

### Effect of the Disclosure

According to this disclosure, for example, the image transfer performed by using the hot melt resin powder can be more appropriately performed.

### BRIEF DESCRIPTION OF THE DRAWINGS

FIG. 1(a) and FIG. 1(b) are views illustrating a printing system 10 according to an embodiment of this disclosure. FIG. 1(a) illustrates an example of a configuration of the printing system 10. FIG. 1(b) illustrates an example of a configuration of a printing unit 14 in the printing system 10.

FIG. 2(a), FIG. 2(b) and FIG. 2(c) are views illustrating a plurality of inkjet heads 202 of a head unit 102 in more detail. FIGS. 2(a), 2(b), and 2(c) illustrate examples of a configuration of the head unit 102.

FIG. 3 is a flowchart illustrating an example of operations executed by the printing system 10 in this example.

FIG. 4(a), FIG. 4(b) and FIG. 4(c) are views illustrating a reason and the like for using a clear ink in this example. FIG. 4(a) illustrates an example of a manner of printing on a transfer medium 50 by a conventional method. FIG. 4(b) illustrates an example of the manner of printing on the transfer medium 50 by a method different from the method illustrated in FIG. 4(a). FIG. 4(c) illustrates an example of the manner of printing on the transfer medium 50 in this example.

FIG. 5(a) and FIG. 5(b) are views illustrating an image to be printed on the transfer medium 50. FIG. 5(a) illustrates an example of an image to be printed on the transfer medium 50. FIG. 5(b) illustrates an example of states of color ink dots constituting the image.

FIG. 6(a), FIG. 6(b) and FIG. 6(c) are views illustrating an example of ejection positions to which the color inks and the clear ink are ejected. FIGS. 6(a), 6(b), and 6(c) illustrate examples of manners of selecting the ejection positions to which the clear ink is ejected.

FIG. 7 is a flowchart illustrating an example of operations of generating print data in a print data preparation unit 12.

FIG. 8(a), FIG. 8(b) and FIG. 8(c) are views illustrating an experiment performed by the inventors of this application. FIG. 8(a) illustrates composition of the clear ink used in the experiment. FIGS. 8(b) and 8(c) illustrate results of the experiment.

### DESCRIPTION OF EMBODIMENTS

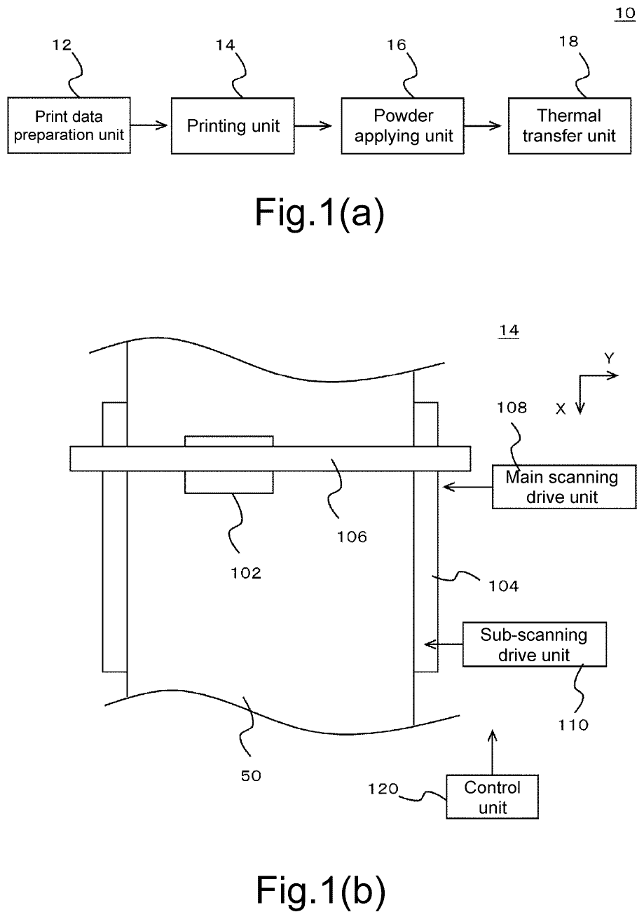

Hereinafter, an embodiment according to this disclosure will be described with reference to the drawings. FIG. 1(a) and FIG. 1(b) are views illustrating a printing system 10 according to an embodiment of this disclosure. FIG. 1(a) illustrates an example of the configuration of the printing system 10. FIG. 1(b) illustrates an example of the configuration of a printing unit 14 in the printing system 10. Except for respects to be described below, the printing system 10 may have the same or similar characteristics as a known printing system 10.

The printing system 10 is a system that draws an image on a transfer-receiving medium (a transfer target) by transferring the image printed on a transfer medium 50 to the transfer-receiving medium, and transfers the image from the transfer medium 50 to the transfer-receiving medium by using hot melt resin powder (hot melt powder) which is powder containing a resin softened through heating. In this example, a medium of cloth such as textile (for example, various fabrics) is used as the transfer-receiving medium. As the transfer-receiving medium, for example, a cloth medium processed into a predetermined product such as a T-shirt may be used. Further, as the transfer medium 50, for example, a known transfer medium used for transfer of the cloth to the transfer-receiving medium can be suitably used. More specifically, as the transfer medium 50, for example, a transfer film for the transfer by a direct to film (DTF) method can be suitably used. Further, as such transfer film, for example, it can be considered to use a PET film or the like. Further, as the transfer medium 50, the medium other than the film (for example, a paper medium) may be used.

Further, as the hot melt resin powder, a known resin powder for the transfer can be suitably used. More specifically, as the hot melt resin powder, for example, a known hot melt resin powder used for transferring the cloth to the transfer-receiving medium can be suitably used. Further, as such hot melt resin powder, for example, powder containing urethane, acrylic, polyester, polyamide, or a mixture thereof can be suitably used. The hot melt resin powder can also be considered as, for example, thermoplastic resin powder. Further, the hot melt resin powder can also be considered as, for example, hot melt adhesive powder for transfer printing. The hot melt adhesive powder can be considered as, for example, a solid adhesive powder at room temperature that mainly contains thermoplastic polymers. Further, the hot melt adhesive powder can also be considered as, for example, a solid adhesive powder containing no water or organic solvent. As such hot melt adhesive powder, for example, multicomponent adhesive powder can be used.

Further, in order to perform the transfer by using the transfer-receiving medium, the transfer medium 50, and the hot melt resin powder as described above, in this example, the printing system 10 includes a print data preparation unit 12, a printing unit 14, a powder applying unit 16, and a thermal transfer unit 18. The print data preparation unit 12 is configured to prepare print data for controlling operations of the printing unit 14. The print data preparation unit 12 generates the print data to be supplied to the printing unit 14 based on image data indicating an image to be printed on the transfer medium 50 in the printing unit 14. As the print data preparation unit 12, for example, it can be considered to use a computer that controls the operations of the printing unit 14 according to a predetermined program. Further, in this example, the print data preparation unit 12 generates the print data by performing halftone processing or the like on the image data in accordance with the configuration of the printing unit 14. Then, the print data preparation unit 12 supplies the print data to the printing unit 14 to control the operations of the printing unit 14 and cause the printing unit 14 to execute a printing operation. An operation of generating the print data in the print data preparation unit 12 will be described in more detail later.

The printing unit 14 has a configuration corresponding to the printing device in the printing system 10. The printing unit 14 executes the printing operation through the inkjet method on the transfer medium 50 based on the print data supplied from the print data preparation unit 12. Further, in this example, the printing unit 14 is a serial type inkjet printer. The printing unit 14 executes the printing operation by causing an inkjet head to perform main scan for ejecting the ink while relatively moving with respect to a printing target in a main scanning direction (a Y direction in the drawing) set in advance. Further, for example, as illustrated in FIG. 1(b), the printing unit 14 includes a head unit 102, a platen 104, a Y bar section 106, a main scanning drive unit 108, a sub-scanning drive unit 110, and a control unit 120.

The head unit 102 is a portion including a plurality of inkjet heads, and ejects the ink from the plurality of inkjet heads toward the transfer medium 50. Further, in this example, the head unit 102 includes a plurality of inkjet heads for color inks that eject the color inks of different colors, and an inkjet head for clear ink that ejects the clear ink. In this case, each of the color inks is an example of the colored ink that is the ink containing the coloring material showing the nonwhite color. Each of the plurality of inkjet heads for the color inks is an example of the colored ink head. The inkjet head for the clear ink is an example of the clear ink head. Further, in this example, the clear ink can be considered as, for example, the colorless and translucent ink. In this case, a fact that the clear ink is colorless can be considered as, for example, that a predetermined color is not intentionally applied. A fact that the predetermined color is not intentionally applied can be considered as, for example, that the coloring material is not intentionally added. Further, the clear ink being colorless and translucent can be considered as, for example, in a transparent state where light of a specific color is not substantially absorbed in a visible light region. A fact that the light of the specific color is not substantially absorbed can be considered as, for example, that the light of the specific color in the visible light region is not substantially absorbed within an allowable range according to a quality required for the printing. More specifically, for example, it can be considered to use an ink without the coloring material of each of the color inks as the clear ink. In this case, in addition to the coloring material, it can be considered to further remove a substance used in connection with the coloring material from each of the color inks. For example, in a case where a dispersant (a pigment dispersant) for dispersing the coloring material such as a pigment in an ink solvent is used in each of the color inks, an ink having a composition without the coloring material and the dispersant of each of the color inks, or the like can be suitably used as the clear ink. Further, the clear ink can be considered as, for example, a transparent ink that is the same as or similar to the clear ink conventionally used in a technical field of inkjet printing. However, as in this example, there is usually no reason to use the clear ink in a field of textile printing for performing printing on the cloth. Therefore, the clear ink used in this example can also be considered to be used in the field of textile printing by extending a manner of using the clear ink used in the inkjet printing other than the textile printing. The configuration of the head unit 102 will be described in more detail later.

The platen 104 is a table-shaped member that supports the transfer medium 50 to face the head unit 102. The Y bar section 106 is a member extending in the main scanning direction at a position facing the platen 104 with the transfer medium 50 interposed therebetween. The Y bar section 106 guides movement of the head unit 102 in the main scanning direction during the main scan by holding the head unit 102 on a face facing the transfer medium 50 in a movable state in the main scanning direction. The main scanning drive unit 108 is a drive unit that causes the plurality of inkjet heads in the head unit 102 to perform the main scan. In this example, the main scanning drive unit 108 causes each of the inkjet heads in the head unit 102 to eject the ink while moving the head unit 102 along the Y bar section 106 according to control of the control unit 120. The sub-scanning drive unit 110 is a drive unit that causes the plurality of inkjet heads in the head unit 102 to perform sub scan. The sub scan can be considered as, for example, an operation of relatively moving with respect to the transfer medium 50 in a sub scanning direction (an X direction in the drawing) orthogonal to the main scanning direction. In this example, the sub-scanning drive unit 110 causes the plurality of inkjet heads in the head unit 102 to perform the sub scan by relatively moving the head unit 102 in the sub scanning direction with respect to the transfer medium 50 during the main scan. The control unit 120 is, for example, a portion including a CPU and the like of the printing unit 14. The control unit 120 controls an operation of each portion of the printing unit 14 based on the print data supplied from the print data preparation unit 12 to control the printing operation on the transfer medium 50. Accordingly, the printing unit 14 prints the image indicated by the image data on the transfer medium 50.

Further, in the printing system 10 of this example, the powder applying unit 16 applies the hot melt resin powder to the transfer medium 50 on which the image is printed in the printing unit 14. It can be considered that the powder applying unit 16 is, for example, configured to cause the hot melt resin powder to adhere to the transfer medium 50 on which the image is printed. Further, in this example, the powder applying unit 16 executes preheating to heat the transfer medium 50 to which the hot melt resin powder adheres to a predetermined temperature before the transfer. Further, after the hot melt powder resin is caused to adhere to the transfer medium 50, the image is transferred from the transfer medium 50 to the transfer-receiving medium in the thermal transfer unit 18. In this example, the thermal transfer unit 18 is an example of the transfer unit. The thermal transfer unit 18 can be considered as, for example, a device that transfers the image from the transfer medium 50 to the transfer-receiving medium by performing heating and pressurization in a state where the transfer medium 50 and the transfer-receiving medium are superimposed on each other. The operation of performing the heating and the pressurization in the state where the transfer medium 50 and the transfer-receiving medium are superimposed on each other can also be considered as, for example, an operation of placing the transfer medium 50 on the transfer-receiving medium and pressure-bonding the transfer-receiving medium. Further, as the thermal transfer unit 18, for example, a known heat press machine or the like can be suitably used. According to this example, for example, the image printed on the transfer medium 50 can be appropriately transferred to the transfer-receiving medium. The image transfer operation executed in the printing system 10 will be described in more detail later.

Note that, in the printing system 10, each of the print data preparation unit 12, the printing unit 14, the powder applying unit 16, and the thermal transfer unit 18 can be considered as a functional configuration or the like in the printing system 10. In this case, for example, a device including a configuration that achieves functions of the printing unit 14 can be considered as an example of the printing device. Further, in a case of considering the configuration of the printing system 10 as the device, a plurality of functional configurations may be achieved by one device. For example, the print data preparation unit 12 and the printing unit 14 may be achieved by one device. In a case of such configuration, for example, the operation of generating the print data from the image data and the operation of executing the printing can be executed by one device. Further, the printing unit 14 and the powder applying unit 16 may be achieved by one device. In a case of such configuration, for example, the printing operation to the preheating operation can be executed by one device. Further, it can also be considered to configure the entire printing system 10 with one device. Moreover, depending on the configuration of the printing system 10, for example, any of the functional configurations illustrated in FIG. 1(a) can also be considered to be configured with a plurality of devices. For example, it can also be considered to configure the powder applying unit 16 with a device for causing the hot melt resin powder to adhere to the transfer medium 50 and a device for the preheating. Further, in any of the configurations, the operation of performing the printing on the transfer medium 50 in the printing unit 14, the operation of causing the hot melt resin powder to adhere to the transfer medium 50 in the powder applying unit 16, and the preheating operation performed in the powder applying unit 16 are preferably executed by a series of devices. In this case, executing a plurality of operations by the series of devices can be considered as, for example, continuously executing the plurality of operations without an operation of carrying the transfer medium 50 by the user.

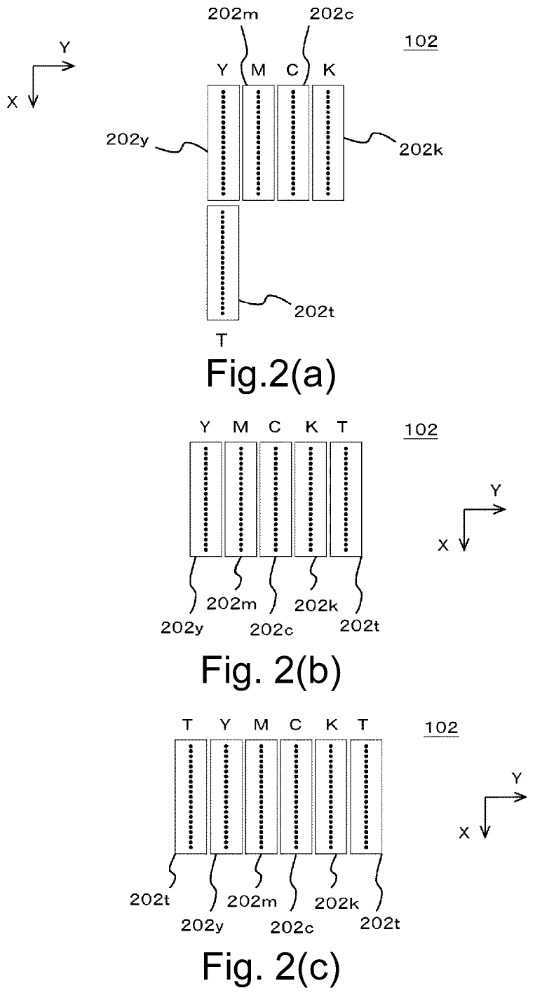

Next, the configuration of the head unit 102 in the printing unit 14 will be described in more detail. FIG. 2(a), FIG. 2(b) and FIG. 2(c) are views illustrating a plurality of inkjet heads 202 of the head unit 102 in more detail. FIGS. 2(a), 2(b), and 2(c) are views illustrating examples of configurations of the head unit 102, and illustrate examples of arrangement manners of the plurality of inkjet heads 202 of the head unit 102. The inkjet heads 202 are denoted by reference signs 202y, 202m, 202c, 202k, and 202t in the drawing to be distinguished. In this example, the head unit 102 includes a plurality of inkjet heads 202y, 202m, 202c, 202k, and 202t that respectively eject inks of different colors. Further, although not illustrated, the head unit 102 further includes, for example, a carriage that holds these inkjet heads 202, and the like.

Further, among these inkjet heads 202, each of the plurality of inkjet heads 202y, 202m. 202c. 202k (hereinafter, referred to as the inkjet heads 202y to 202k) is an inkjet head that ejects respective color inks, and ejects a colored ink of a color different from others. More specifically, the inkjet head 202y ejects a yellow (Y) ink. The inkjet head 202m ejects a magenta (M) ink. The inkjet head 202c ejects a cyan (C) ink. The inkjet head 202k ejects a black (K) ink. In this case, the ink of each color of YMCK is an example of an ink of each of process colors which is a basic color used for color expression in a subtractive color mixing method.

As the ink of each color of YMCK ejected from each of the inkjet heads 202y to 202k, for example, it can be considered to use a known color ink. As the known color ink, for example, an ink for the textile printing used in a case of performing the printing on the cloth by the transfer can be suitably used. As such ink for the textile printing, for example, an ink containing a pigment as the coloring material can be suitably used. More specifically, in this example, the ink of each color of YMCK is an ink that fixes to the transfer medium 50 by evaporation of a solvent, and includes the pigment, the dispersant, the binder resin, the solvent, and the like. In this case, the pigment is an example of the coloring material. The dispersant is a substance for dispersing the pigment in the solvent. The binder resin is a resin for fixing the pigment to the transfer medium 50. The binder resin can also be considered as, for example, a resin that fixes to the transfer medium 50 together with the coloring material in the colored ink. The solvent is a liquid that dissolves or disperses other components in the ink. As the solvent, an aqueous solvent such as water can be suitably used. Further, as the ink solvent, for example, a solvent (an organic solvent) other than the aqueous solvent may be used. More specifically, in this example, as the ink of each color of YMCK used in the inkjet heads 202y to 202k, an aqueous pigment ink for the textile printing used for transferring the cloth to the transfer-receiving medium is used. In this case, a known aqueous pigment ink can be suitably used.

The inkjet head 202t is an inkjet head that ejects the clear ink. In this example, the clear ink is the colorless and translucent ink containing no coloring material such as the pigment. More specifically, as the clear ink, for example, an ink having a composition without the pigment and the dispersant of the ink of each color of YMCK can be suitably used. In this case, the clear ink can also be considered as, for example, the ink that fixes to the transfer medium 50 by the evaporation of the solvent. Further, the clear ink can be considered to contain, for example, the same resin as the binder resin in the ink of each color of YMCK. According to such configuration, for example, it is possible to appropriately use the clear ink having close characteristics to those of the ink of each color of YMCK. Further, as the clear ink, for example, an ink that does not contain the same resin as the binder resin in the ink of each color of YMCK may be used.

In the head unit 102, for example, the inkjet heads 202y to 202k are arranged in the main scanning direction with positions thereof aligned in the sub scanning direction. In this case, as illustrated in FIG. 2(a), for example, a position of the inkjet head 202t in the sub scanning direction may be made different from those of the inkjet heads 202y to 202k. Alternatively, as illustrated in FIGS. 2(b) and 2(c), the inkjet head 202t may have the same position in the sub scanning direction as the inkjet heads 202y to 202k. More specifically, in the example illustrated in FIG. 2(a), the inkjet head 202t is disposed on one side in the sub scanning direction with respect to the arrangement of the inkjet heads 202y to 202k. In the example illustrated in FIG. 2(b), the inkjet head 202t is disposed on one side in the main scanning direction with respect to the arrangement of the inkjet heads 202y to 202k. Further, the number of inkjet heads 202t in the head unit 102 may be multiple, for example, as illustrated in FIG. 2(c). In the example illustrated in FIG. 2(c), each of a plurality of inkjet heads 202t is disposed on one side and the other side in the main scanning direction with respect to the arrangement of the inkjet heads 202y to 202k. Further, the arrangement of the inkjet heads 202y to 202k, and 202t in the head unit 102 may be different from those in FIGS. 2(a), 2(b), and 2(c). For example, among the inkjet heads 202y to 202k, some of the inkjet heads 202 may have positions in the sub scanning direction different from the other inkjet heads 202.

Here, in this example, for example, it can be considered to use, as the transfer medium, a transfer film on which an ink-receiving layer (a receiving layer) that absorbs the inks is formed. The ink-receiving layer can be considered as, for example, a layer for preventing the smearing of the inks by absorbing the inks before the inks excessively spread on the transfer medium. By using such transfer medium, for example, the occurrence of the smearing of the color inks can be appropriately prevented. Further, in this case, in order to more appropriately prevent the smearing of the color inks, for example, the printing is preferably performed to impact the color inks before the clear ink at each position on the transfer medium in the printing unit 14 (see FIG. 1(a) and FIG. 1(b)). The impact of the color inks before the clear ink can be considered as, for example, the impact of the color ink of any color before the clear ink in a case where the color ink and the clear ink are ejected to the same position. Further, as described above, for example, the medium other than the film such as the paper medium may be used as the transfer medium. Also in this case, for example, it is possible to appropriately prevent the occurrence of the smearing of the inks and appropriately perform the printing on the transfer medium by using the transfer medium on which the receiving layer is formed.

Further, in this case, in the head unit 102 having the configuration illustrated in FIG. 2(a), for example, it can be considered to dispose the inkjet head 202t on a downstream side lower than the inkjet heads 202y to 202k in a conveyance direction of the transfer medium. The conveyance direction of the transfer medium can be considered as, for example, a direction where the transfer medium moves relative to the head unit 102. Further, in a case where the head unit 102 having the configuration illustrated in FIG. 2(b) is used, for example, a relative moving direction of the head unit 102 with respect to the transfer medium during the main scan can be considered as a direction where the inkjet head 202t is on a rear side with respect to the inkjet heads 202y to 202k. Further, in a case of using the head unit 102 having the configuration illustrated in FIG. 2(b), for example, it can also be considered that the relative moving direction with respect to the transfer medium during the main scan is bidirectional, one direction and the other direction, and the clear ink is ejected from the inkjet head 202t only during the main scan in one direction. Further, in a case of using the head unit 102 having the configuration illustrated in FIG. 2(c), for example, it can be considered that the relative moving direction with respect to the transfer medium during the main scan is bidirectional, and the clear ink is ejected from the inkjet head 202t on the rear side with respect to the inkjet heads 202y to 202k during the main scan in respective moving directions. Further, depending on the quality and the like required for the printing, for example, the clear ink may be impacted before the color ink at each position on the transfer medium. Further, in this case, for example, it can be considered that the head unit 102 having the configuration illustrated in FIG. 2(b) is used, the relative moving direction with respect to the transfer medium during the main scan is bidirectional, and the clear ink is ejected from the inkjet head 202t during movement in both directions.

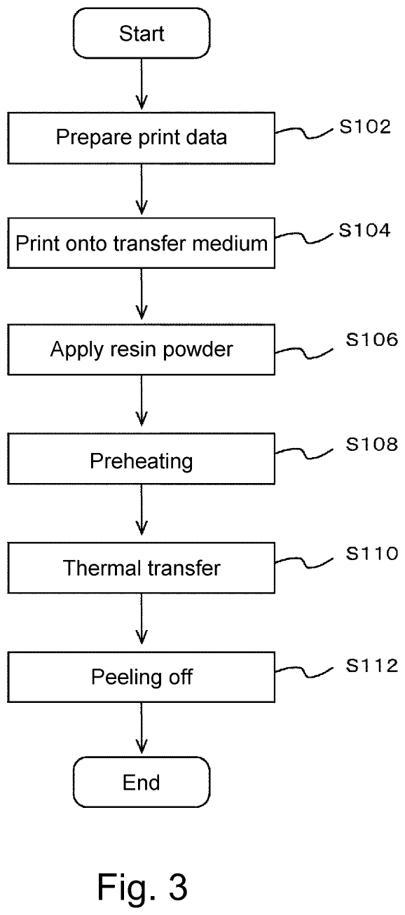

Next, the image transfer operation and the like executed in the printing system 10 will be described in more detail. FIG. 3 is a flowchart illustrating an example of operations executed by the printing system 10 in this example.

As described above, in the printing system 10 of this example, the image printed on the transfer medium in the printing unit 14 is transferred to the transfer-receiving medium. Further, in this case, first, the print data preparation unit 12 generates the print data to be supplied to the printing unit 14 based on the image data indicating the image to be printed on the transfer medium (S102). The operation of generating the print data in the print data preparation unit 12 will be described in more detail later. Further, in this case, the printing unit 14 prints the image on the transfer medium based on the print data supplied from the print data preparation unit 12 (S104). In this example, the operation of step S104 is an example of an operation of the printing stage. In step S104, the printing unit 14 ejects the color inks from the inkjet heads 202y to 202k in the head unit 102 to at least a part of the transfer medium. Then, the clear ink is further ejected from the inkjet head 202t to at least a part of a region to which the color ink is ejected from any one of the inkjet heads 202y to 202k in the transfer medium. A reason for using the clear ink, a manner of ejecting the clear ink, and the like in this example will be described in more detail later.

Further, after the printing is performed on the transfer medium by the printing unit 14, the powder applying unit 16 causes the hot melt resin powder to adhere to the transfer medium on which the image is printed (S106). In this example, the operation of step S106 is an example of an operation in the hot melt resin adhering stage. In step S106, application of the hot melt resin powder to the transfer medium in the powder applying unit 16 can be, for example, performed identically or similarly to application of the hot melt resin powder in a known transfer operation performed by using the hot melt resin powder. More specifically, it can be considered to automatically apply the hot melt resin powder to the transfer medium by, for example, a device. In this case, the powder applying unit 16 has, for example, a powder jetting unit that jets the hot melt resin powder toward the transfer medium. Further, the application of the hot melt resin powder to the transfer medium may be manually performed by a user (an operator). In this case, the powder applying unit 16 causes the user to perform an operation of applying the hot melt resin powder to the transfer medium by holding the transfer medium on which the image is printed in a predetermined state, for example.

Note that, in this example, the hot melt resin powder applied to the transfer medium adheres to the inks on the transfer medium to adhere to the transfer medium. Therefore, in the transfer medium, the hot melt resin powder adheres only to positions to which the inks are ejected by the printing unit 14 in step S104. Further, in this case, the hot melt resin powder at positions to which the inks are not ejected in the transfer medium is, for example, removed from the transfer medium identically or similarly to a known method, before the preheating is executed in a next process. The removal of the hot melt resin powder may be automatically performed by a device or may be manually performed by the user.

Further, the powder applying unit 16 causes the hot melt resin powder to adhere to the transfer medium, removes unnecessary hot melt resin powder, and then executes the preheating on the transfer medium (S108). In this case, it can be considered to heat the transfer medium until a temperature at which the hot melt resin powder is melted is reached. According to such configuration, for example, the hot melt resin powder can be appropriately fixed to the transfer medium. The fixing of the hot melt resin powder to the transfer medium can be considered as, for example, fixing of the hot melt resin powder to the transfer medium in a state where the hot melt resin powder can be transferred to the transfer-receiving medium later. Further, the preheating can also be considered as, for example, an operation of heating the transfer medium at a predetermined temperature to bring the hot melt resin powder into an adhesive state. The preheating executed in step S108 can also be, for example, performed identically or similarly to a known method. More specifically, in step S108, for example, it can be considered to heat the transfer medium to make the temperature of the hot melt resin powder about 130° C. (for example, about 120 to 150° C.) and maintain in such state for about 5 minutes (for example, about 1 to 10 minutes).

Further, after the preheating is performed, the transfer (the thermal transfer) from the transfer medium to the transfer-receiving medium is executed in the thermal transfer unit 18 (S110). In this example, the operation of step S110 is an example of an operation of the transfer stage. In step S110, the thermal transfer unit 18 performs the heating and the pressurization in the state where the transfer medium and the transfer-receiving medium are superimposed on each other. Accordingly, the hot melt resin powder is softened by the heating, and a hot melt resin portion which is a resin portion is formed. The thermal transfer unit 18 causes the hot melt resin portion to adhere to the transfer-receiving medium. The hot melt resin portion can be considered as, for example, a resin portion made of a hot melt resin powder that has become sticky by the heating. The hot melt resin portion may be, for example, a resin formed by mixing the softened hot melt resin powder. Further, in this example, in step S110, the coloring material expressing the color in the image printed on the transfer medium is caused to adhere to the transfer-receiving medium together with at least a part of the hot melt resin portion, to transfer the image from the transfer medium to the transfer-receiving medium. Such operation can be considered as, for example, an operation of transferring the image from the transfer medium to the transfer-receiving medium by moving at least the part of the coloring material adhering to the transfer medium to the transfer-receiving medium together with at least the part of the hot melt resin portion. The transfer executed in step S110 can also be, for example, performed identically or similarly to a known method. More specifically, in step S110, for example, the hot melt resin portion is caused to adhere to the transfer-receiving medium by performing the pressurization while performing the heating at a temperature higher than a temperature of the preheating in step S108. In this case, for example, it can be considered to heat the transfer medium and the transfer-receiving medium to make a temperature of the hot melt resin portion about 140° C. (for example, about 100 to 180° C.). Further, it can be considered to make heating and pressurization time in step S110 shorter than heating time in the preheating in step S108. For example, it can be considered to set the heating and pressurization time in step S110 to about 5 seconds (for example, about 1 to 30 seconds).

After the image is transferred from the transfer medium to the transfer-receiving medium in step S110, for example, the transfer medium is peeled off from the transfer-receiving medium (S112). In this case, for example, the transfer-receiving medium to which the image is transferred can be considered as a printed product (a printed matter) by the printing system 10. The peeling off of the transfer medium in step S112 can also be, for example, performed identically or similarly to a known method. Further, in this example, for example, a transfer medium having a surface on which a release layer is formed can be suitably used. According to such configuration, for example, the transfer medium can be easily and appropriately peeled off in step S112.

By the above operations, the printing system 10 can appropriately create the printed product. Further, in this case, by using the clear ink in addition to the color inks during the printing on the transfer medium, for example, it is possible to reduce the transfer unevenness by improving the transferability, and lighten the graininess. Therefore, the reason for using the clear ink in this example, the manner of ejecting the clear ink, and the like will be described in more detail below.

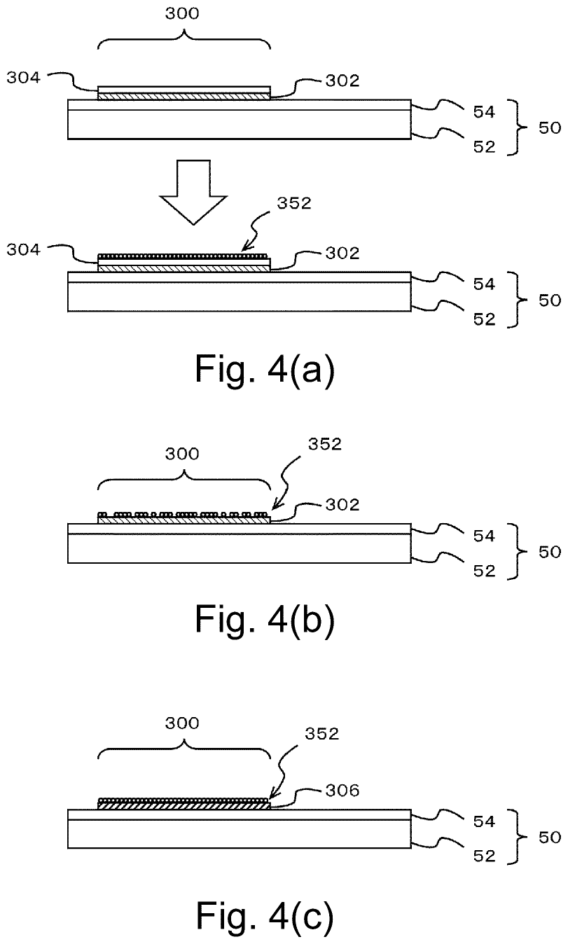

FIG. 4(a), FIG. 4(b) and FIG. 4(c) are views illustrating the reason for using the clear ink in this example, and illustrates an example of the manner of printing on the transfer medium 50 in this example as compared with a manner of printing on the transfer medium 50 by a conventional method, or the like. FIG. 4(a) illustrates the example of the manner of printing on the transfer medium 50 by the conventional method. FIG. 4(b) illustrates the example of the manner of printing on the transfer medium 50 by the method different from the method illustrated in FIG. 4(a). FIG. 4(c) illustrates an example of the manner of printing on the transfer medium 50 in this example.

As described above, in this example, it can be considered to use the transfer medium 50 on which an ink-receiving layer 54 is formed. Further, also in the conventional method, such transfer medium 50 can be suitably used. Then, in this case, the transfer medium 50 includes a base portion 52 and the ink-receiving layer 54 as illustrated in each of FIGS. 4(a) to 4(c). The base portion 52 is a portion as a base of the transfer medium 50. The ink-receiving layer 54 is a layer for absorbing the inks, and is formed on a surface of the base portion 52. The ink-receiving layer 54 can also be considered to, for example, constitute a part of the base portion 52. In this case, the base portion 52 can also be considered to constitute the entire transfer medium 50. Further, in this example, the printing unit 14 (see FIG. 1(a) and FIG. 1(b)) in the printing system 10 performs the printing on the transfer medium 50 by ejecting the inks onto the ink-receiving layer 54 in the transfer medium 50 to form an ink layer on the transfer medium 50. Further, also in a conventional configuration, the printing is similarly performed on the transfer medium 50 by forming the ink layer on the transfer medium 50 with a printing device corresponding to the printing unit 14.

Further, for example, in the conventional method illustrated in FIG. 4(a), there is a configuration different from the printing unit 14 of this example. In the conventional method, a printing device, is used, including inkjet heads for color inks and an inkjet head for a white ink. The printing device forms a color ink layer 302 and a white ink layer 304 on a printing region 300 on a surface of the transfer medium 50. In this case, the color ink layer 302 is an ink layer formed with the color inks. The white ink layer 304 is an ink layer formed with the white ink. The white ink layer 304 can be considered as, for example, a layer that conceals the base color of the transfer-receiving medium after the transfer, and functions as a background in the subtractive color mixing method. The printing region 300 can be considered as, for example, a region to which the color inks are ejected from the inkjet heads. Further, in this case, for example, the color ink layer 302 is formed on the transfer medium 50, as illustrated in the drawing. The white ink layer 304 is formed on the color ink layer 202 to cover the entire color ink layer 302. Further, the white ink layer 304 is formed, for example, to fill the printing region 300 in a solid manner at a predetermined density.

In this case, after the color ink layer 302 and the white ink layer 304 are formed on the transfer medium 50, the hot melt resin powder illustrated as resin powder 352 in the drawing is caused to adhere onto the white ink layer 304, as illustrated in a lower portion of FIG. 4(a). Further, after adhesion of the resin powder 352, the transfer medium 50 and the transfer-receiving medium are superimposed on each other, and the image is transferred from the transfer medium 50 to the transfer-receiving medium by performing the heating and the pressurization. In a case of performing the printing and the transfer in such manner, the amount of the ink at each position on the printing region 300 becomes sufficiently large by forming the white ink layer 304 in the solid manner. Therefore, the resin powder 352 can be caused to appropriately adhere to the printing region 300 on the transfer medium 50. Accordingly, for example, even in a case of transferring an image including the low gradation region in which the amount of the ink decreases in the color ink layer 302, the image can be appropriately transferred with high quality by appropriate adhesion of the resin powder 352. Further, in this case, after the image is transferred, the white ink layer 304 becomes a layer below the color ink layer 302, and functions as a background of the color ink layer 302 on the transfer-receiving medium. Therefore, for example, even in a case where a dark fabric or the like is used as the transfer-receiving medium, the image can be appropriately represented on the transfer-receiving medium.

However, in this case, even a portion corresponding to the white ink layer 304 is transferred to the transfer-receiving medium separately from the original image, which may impair the design and the texture of the transfer-receiving medium. For example, there are a case where a fabric of a light (bright) color such as white or beige as the transfer-receiving medium, a case where a design, is expressed, utilizing the color and a texture of the fabric used as the transfer-receiving medium (for example, a case where a raw fabric is used). In these cases, it is not preferable to form the white ink layer 304. Further, in a case where the fabric or the like of the light color such as white is used as the transfer-receiving medium, the based color of the transfer-receiving medium after the transfer is a light reflective color. Therefore, the color can be appropriately expressed in the subtractive color mixing method without forming the white ink layer 304. Then, in such case, for example, it can also be considered to transfer the image without forming the white ink layer 304, as illustrated in FIG. 4(b). In this case, the color ink layer 302 is formed on the printing region 300 in the transfer medium 50 by using the printing device having the inkjet heads for the color inks. Then, the resin powder 352 is caused to directly adhere onto the color ink layer 302. Further, after the adhesion of the resin powder 352, the transfer medium 50 and the transfer-receiving medium are superimposed on each other, and the image is transferred from the transfer medium 50 to the transfer-receiving medium by performing the heating and the pressurization. Also in such case, the image can be transferred from the transfer medium 50 to the transfer-receiving medium. However, depending on a state of the image drawn on the transfer medium 50, the transfer rate decreases in a part of the image, and unintended transfer unevenness may occur.

More specifically, the color ink layer 302 is formed by ejecting each of the ink colors in accordance with the image drawn on the transfer medium 50. Then, in this case, the amounts of the inks to be ejected vary depending on the positions in the printing region 300. For example, the amounts of the inks are less in the low gradation region expressing the light colors in the image than in the high gradation region expressing the darker colors. Further, as a result, a manner of the adhesion of the resin powder 352 easily varies depending on the positions in the printing region 300. Then, in this case, for example, an adhesion amount of the resin powder 352 may decrease, leading to the deterioration of the transferability in the low gradation region where the amounts of the inks decrease. Further, as a result, it can be considered that the transfer unevenness occurs. Moreover, it can also be considered that expression of the low gradation becomes poor due to the deterioration of transferability, and the like. In this regard, for example, in the case of the method illustrated in FIG. 4(a), a difference in the transferability can be appropriately prevented from occurring, since the white ink layer 304 in the solid manner is formed on the color ink layer 302, even if the amounts of the color inks ejected to each position vary. However, in a case of the method illustrated in FIG. 4(b), the transfer unevenness is likely to occur without forming the white ink layer 304 as described above.

On the other hand, in this example, the occurrence of the transfer unevenness is prevented without forming the white ink layer 304 by using the clear ink in addition to the color inks. In this case, for example, as illustrated in FIG. 4(c), the image layer 306, which is an ink layer formed with the color inks and the clear ink, is formed on the printing region 300 of the transfer medium 50 by using the color inks and the clear ink in the printing unit 14. Then, the resin powder 352 is caused to directly adhere onto the image layer 306 without forming the white ink layer 304 or the like. Further, after the adhesion of the resin powder 352, the transfer medium 50 and the transfer-receiving medium are superimposed on each other, and the image is transferred from the transfer medium 50 to the transfer-receiving medium by performing the heating and the pressurization.

Accordingly, in this example, by using the clear ink in addition to the color inks during the printing on the transfer medium 50 with the printing unit 14, for example, it is possible to appropriately eject the ink other than the color inks to the transfer medium 50 while appropriately suppressing the influence of the colors of the image to be printed on the transfer medium 50. Thus, for example, in the printing region 300, the clear ink is ejected even to a position where the amounts of the color inks decrease, such as the low gradation region. Accordingly, the total amount of the inks ejected to the transfer medium 50 can be increased as compared with a case of using only the color inks. Further, for example, the resin powder 352 can be caused to more appropriately adhere to the transfer medium 50 by increasing the total amount of the inks. Accordingly, for example, during the transfer of the image from the transfer medium 50 to the transfer-receiving medium, it is possible to appropriately prevent the deterioration of the transferability due to insufficient resin powder 352, the occurrence of the transfer unevenness, or the like. Therefore, according to this example, for example, the image transfer performed by using the resin powder 352 can be more appropriately performed without forming the white ink layer 304. Further, in this case, unlike the white ink containing a white pigment or the like, it is possible to use the clear ink while suppressing influence on the design and the like. Further, since the clear ink becomes less conspicuous on the transfer-receiving medium after the transfer, for example, it is also possible to select and use only necessary portions. Therefore, according to this example, for example, it is possible to perform the transfer with a higher quality while appropriately preventing impairment of the design and the texture.

Further, in this example, the graininess after the transfer can be lighten, for example, by using the clear ink in addition to the color inks. More specifically, as in this example, in a case of performing the printing through the inkjet method on the transfer medium 50 having the ink-receiving layer 54, it can be considered that the impacted inks are less likely to wet and spread on the transfer medium 50. Further, as a result, for example, it can be considered that the graininess is likely to occur particularly in the low gradation region. Moreover, in a case where the transfer is performed by the adhesion of the resin powder 352, it can be considered that the adhesion amount of the resin powder 352 depends on the amounts (printing amounts) of the inks ejected to that position. Therefore, for example, in a case where the image is transferred by the method as illustrated in FIG. 4(b), the adhesion amount of the resin powder 352 decreases in the low gradation region where the printing amount is small, and the graininess is more conspicuous in the transfer-receiving medium after the transfer due to the deterioration of the transferability.

On the other hand, in this example, by using the clear ink in addition to the color inks, for example, the color inks on the transfer medium 50 can be made to wet and spread more easily as compared with the case of using only the color inks. Accordingly, for example, it is possible to increase the sizes of ink dots formed on the transfer medium 50 with the color inks, and make the graininess less likely to occur. Further, in this case, as described above, the deterioration of the transferability can be appropriately prevented in the low gradation region by using the clear ink. Therefore, for example, it is possible to more appropriately prevent the graininess from becoming conspicuous in the transfer-receiving medium after the transfer. Further, in this case, for example, the printing unit 14 preferably ejects the color inks and the clear ink to impact the clear ink before the color inks are completely dried at each of the positions to which the color inks are ejected on the transfer medium 50. According to such configuration, for example, a state where the color inks are likely to wet and spread on the transfer medium 50 can be more appropriately achieved.

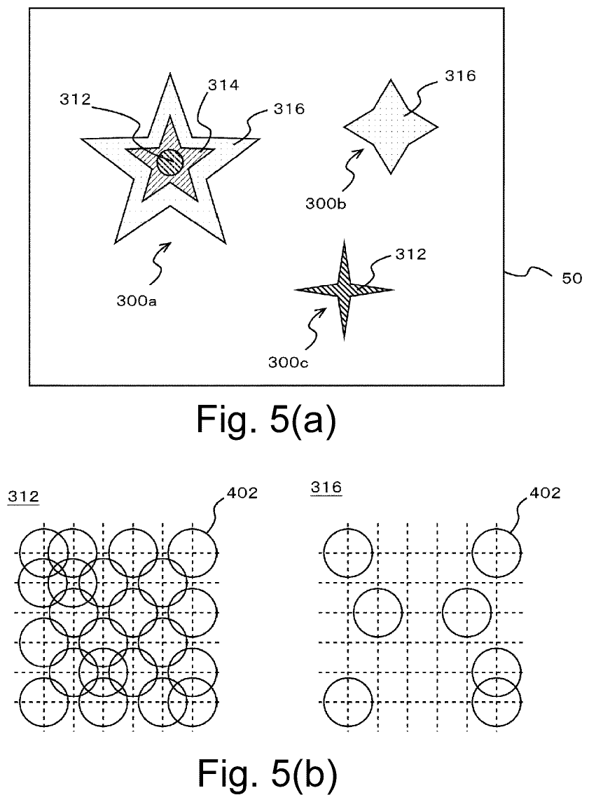

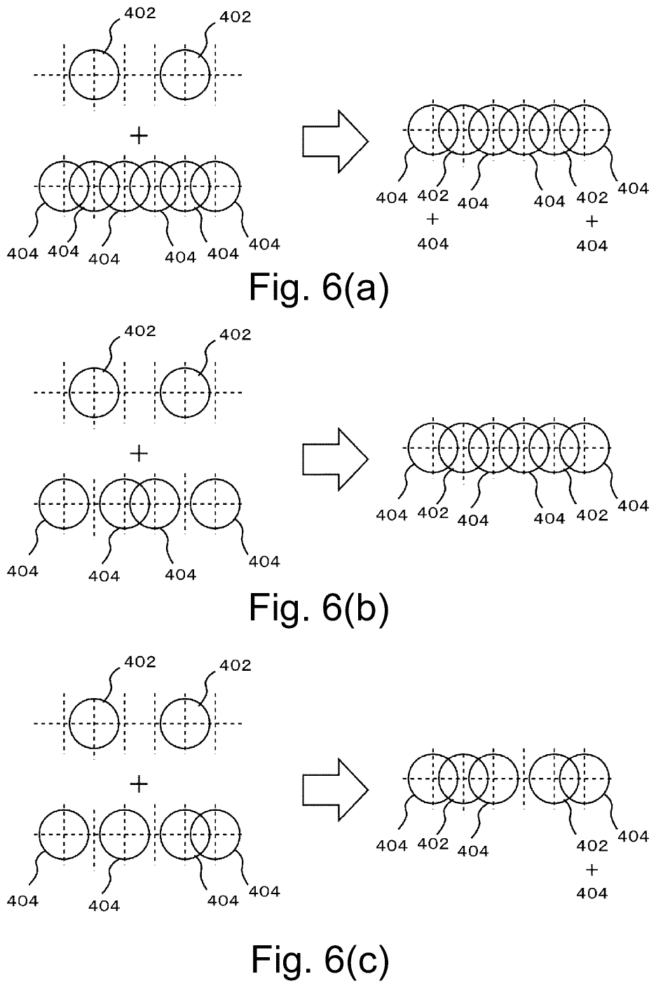

Further, as can be understood from the above description and the like, in particular, the clear ink is preferably ejected to a position that becomes the low gradation region in the image, in this example. Therefore, hereinafter, an example of the manner of ejecting the clear ink will be described in more detail. FIGS. 5 and 6 are views illustrating examples of the manner of ejecting the clear ink in this example. FIG. 5(a) and FIG. 5(b) are views illustrating an image to be printed on the transfer medium 50. FIG. 5(a) illustrates an example of the image to be printed on the transfer medium 50. FIG. 5(b) illustrates an example of the states of the color ink dots constituting the image.

As in this example, in a case of performing the printing (color printing) by using a plurality of the color inks by the printing unit 14 (see FIG. 1(a) and FIG. 1(b)), the amount of each of the color inks to be ejected to each position on the transfer medium 50 varies according to a color expressed at each position. Further, in this case, for example, it can be considered that a gradation varies depending on a position of the image. Then, the printing unit 14 prints, for example, an image including a high gradation portion 312, a medium gradation portion 314, and a low gradation portion 316 on the transfer medium 50. More specifically, FIG. 5(a) illustrates an example of the image to be printed in a case where the printing unit 14 performs the printing on a plurality of printing regions 300a to 300c. In this case, the printing region 300 a is a printing region including the high gradation portion 312, the medium gradation portion 314, and the low gradation portion 316. The printing region 300b is a printing region including only the low gradation portion 316. The printing region 300c is a printing region including only the high gradation portion 312. Further, in this example, each of the printing regions 300a to 300c is an example of an image representing region to which the color inks are ejected from any of the inkjet heads 202y to 202k (see FIG. 2(a), FIG. 2(b) and FIG. 2(c)) in the transfer medium 50.

Further, in this case, the high gradation portion 312 can be considered as, for example, a portion expressing colors at a gradation higher than a predetermined first reference in the image. In this case, a fact that the gradations of the image are higher than the first reference can be considered as, for example, that the gradation of the color corresponding to any of the color inks (any color of YMCK) is higher than the first reference. Further, the medium gradation portion 314 can be considered as, for example, a portion other than the high gradation portion 312 and the low gradation portion 316 in the image. The low gradation portion 316 can be considered as, for example, a portion expressing a color at gradation lower than a predetermined second reference, which is lower than the first reference in the image. In this case, a fact that the gradations of the image are higher than the second reference can be considered as, for example, that the gradations of all colors (all the colors of YMCK) in the color inks are lower than the second reference. Further, the high gradation portion 312 can also be considered as, for example, a portion expressing a color in a predetermined high gradation region. The high gradation portion 312 can also be considered as, for example, a region expressing the dark colors or deep colors in the image. Further, the low gradation portion 316 can also be considered as, for example, a region expressing colors in a predetermined low gradation region. The low gradation portion 316 can also be considered as, for example, a portion expressing the light colors or the bright colors in the image.

Further, in the case of performing the printing through the inkjet method as in the printing unit 14 of this example, the gradations are expressed by changing densities of the ink dots formed per unit area. Then, in this case, in the high gradation portion 312, for example, many dots 402 are densely formed, as illustrated on a left side of FIG. 5(b). Further, in the low gradation portion 316, for example, a small number of the dots 402 are sparsely formed as compared with the high gradation portion 312, as illustrated on a right side of FIG. 5(b). In FIG. 5(b), intersections of vertical and horizontal broken lines indicate ink ejection positions set according to the resolution of the printing. Then, in this case, each of the high gradation portion 312, the medium gradation portion 314, and the low gradation portion 316 in the image can be considered in association with the amounts of the color inks ejected per unit area. More specifically, in this case, the high gradation portion 312 can be considered as, for example, a region to which the amounts of the color inks ejected per unit area are increased. Further, the low gradation portion 316 can be considered as, for example, a region to which the amounts of the color inks ejected per unit area are reduced.

Further, in this example, the low gradation portion 316 is an example of the small amount of ink region, which is a region to which the amounts of the color inks ejected per unit area are less than a preset reference amount. The high gradation portion 312 is an example of the non-small amount of ink region, which is at least a part of a region not corresponding to the small amount of ink region. The non-small amount of ink region can be considered as, for example, a region in which the amounts of the color inks ejected per unit area are larger than a predetermined amount in each of the printing regions 300a to 300c. Further, in this example, this predetermined amount can be considered to be an amount larger than the above reference amount related to the small amount of ink region. Depending on the configuration and the like of the printing unit 14, for example, a portion combining the high gradation portion 312 and the medium gradation portion 314 can also be considered as an example of the non-small amount of ink region. In this case, the above predetermined amount related to the non-small amount of ink region can be considered as, for example, the same amount as the reference amount related to the small amount of ink region.

Further, as described above, in this example, the printing unit 14 performs the printing on the transfer medium 50 by using the clear ink in addition to the color inks. Then, in this case, the clear ink is ejected to at least a part of the low gradation portion 316 in the image. Further, in this case, for example, it can be considered to eject the color inks and the clear ink to the ejection positions set on the transfer medium 50 according to the resolution of the printing, as illustrated in FIG. 6(a), FIG. 6(b) and FIG. 6(c).

FIG. 6(a), FIG. 6(b) and FIG. 6(c) are views illustrating an example of ejection positions to which the color inks and the clear ink are ejected. FIG. 6(a), FIG. 6(b) and FIG. 6(c) illustrate an example of the ejection positions to which the color inks and the clear ink are ejected, focusing on the plurality of the ejection positions in a part of the low gradation portion 316 (see FIG. 5(a) and FIG. 5(b)). FIGS. 6(a) to 6(c) are views illustrating the examples of the manners of selecting the ejection positions to which the clear ink is ejected. FIGS. 6(a) to 6(c) illustrates various examples of the manner of ejecting the clear ink to positions where the color ink dots 402 are discretely formed in the low gradation portion 316. The positions where the color ink dots 402 are discretely formed can be considered as, for example, positions where a plurality of the color ink dots 402 are formed with a space therebetween, as illustrated in an upper left side of each of FIGS. 6(a) to 6(c). Further, in this case, the plurality of dots 402 can be considered to spread to a size that does not contact with each other. Then, in this case, for example, if the clear ink is not used, it can be considered that the amounts of the inks per unit area decrease, and the transferability is deteriorated.

On the other hand, in this example, the amounts of the inks per unit area are increased by further using the clear ink, as described above. Then, as for the manner of ejecting the clear ink, in a case of considering an increase in the total amount of the inks ejected near each of the ejection positions, for example, it can be considered to eject a predetermined amount of the clear ink to all the ejection positions, as illustrated in a lower left side of FIG. 6(a). In this case, the drawing on the lower left side illustrates arrangement of ink dots 404 formed with the clear ink at the same positions as the plurality of the ejection positions illustrated on the upper left side. Further, in a case illustrated in FIG. 6(a), the clear ink dots 404 are formed at all the ejection positions arranged at intervals corresponding to the resolution of the printing. Then, in this case, if the color ink dots 402 and the clear ink dots 404 are combined, the clear ink dots 404 are formed at both positions with the color ink dots 402 and positions without the color ink dots 402, as illustrated on a right side of the drawing. In a case of such configuration, for example, there will be a state where the amounts of the inks are supplemented by adding the clear ink to the low gradation region where the amounts of the color inks decrease. Therefore, according to such configuration, for example, the total amount of the inks ejected near each of the ejection positions can be appropriately increased.

However, depending on the quality and the like required for the printing, it may be preferable to eject the clear ink only to some of the ejection positions rather than to eject the clear ink to all the ejection positions. More specifically, for example, in a case where the amounts of the inks per unit area become excessive if the clear ink is ejected to all the ejection positions, it can also be considered to reduce the positions to which the clear ink is ejected in accordance with a preferred upper limit amount of the ink, and the like. Then, in this case, for example, the clear ink dots 404 may be formed only at some of the ejection positions, as illustrated in FIGS. 6(b) and 6(c).

More specifically, in a case of the example illustrated in FIG. 6(b), only the ejection positions where the color ink dots 402 are not formed are selected to form the clear ink dots 404, as illustrated on a lower left side of the drawing. Then, in this case, if the color ink dots 402 and the clear ink dots 404 are combined, either the color ink dots 402 or the clear ink dots 404 are formed at each of the ejection positions, as illustrated on a right side of the drawing. Also in a case of such configuration, for example, there will be the state where the amounts of the inks are supplemented by adding the clear ink to the low gradation region where the amounts of the color inks decrease. Therefore, also in the case of such configuration, for example, the total amount of the inks ejected near each of the ejection positions can be appropriately increased.

Further, the ejection positions to which the clear ink is ejected do not necessarily required to strictly match the ejection positions to which the color inks are ejected. More specifically, in the case of performing the printing through the inkjet method, the ejection positions to which the color inks are ejected are determined, for example, by the halftone processing. Then, in this case, usually, even if the gradations to be expressed are the same, the positions to which the color inks are ejected are not necessarily the same. Further, in this example, in a case of ejecting the clear ink to only some of the ejection positions, it can be considered to determine the positions to which the clear ink is ejected also by, for example, predetermined processing such as the halftone processing. Then, in this case, the ejection positions to which the clear ink is ejected are also determined by a result of the processing. Then, in such case, it can be considered to determine a relationship between the ejection positions to which the color inks are ejected and the ejection positions to which the clear ink is ejected as, for example, a relationship of the gradations of the image before the halftone processing or the like is performed or a relationship of the amounts of the inks ejected per unit area, instead of determining the relationship strictly as a predetermined relationship. Then, in this case, for example, as illustrated in FIG. 6(c), the color ink dots 402 and the clear ink dots 404 are formed at some of the ejection positions among the ejection positions where the color ink dots 402 are formed. At other ejection positions, the clear ink dots 404 are not formed, but only the color ink dots 402 are formed. Further, the clear ink dots 402 are formed only at some of the ejection positions where the color ink dots 404 are not formed. Also in a case of such configuration, for example, the state, can be considered, where the amounts of the inks are supplemented by adding the clear ink to the low gradation region where the amounts of the color inks decrease. Therefore, also in the case of such configuration, for example, the total amount of the inks ejected near each of the ejection positions can be appropriately increased.

Further, the manner of selecting the ejection positions to which the clear ink is ejected is not limited to the method described above, and may be performed by other methods. For example, the ejection positions where the color ink dots 402 are formed may be confirmed based on the result of the halftone processing, and the ejection positions where the dots 404 are formed may be determined in accordance with that ejection positions. In this case, for example, it can be considered to form the clear ink dots 404 at the ejection positions where the color ink dots 402 are formed, such as ejection positions adjacent to the ejection positions where the color ink dots 402 are formed. Further, in this case, the clear ink dots 404 may be further formed at the ejection positions where the color ink dots 402 are formed.

Further, as can be understood from the above description and the like, in this example, adhesiveness of the hot melt resin powder is enhanced by ejecting the clear ink to portions where the ejection amounts of the color inks decrease in the printing region on the transfer medium 50. The, in this case, a sufficient amount of the hot melt resin powder can be caused to adhere to portions where the amounts of the color inks to be ejected is sufficiently large without using the clear ink. Further, for example, in a case where the total amount of the inks including the color inks and the clear ink becomes too large with respect to the amounts of the inks ejected per unit area, it can also be considered that a problem such as smearing of the color inks or the like trends to occur. Therefore, the ejection amount of the clear ink to each position on the transfer medium 50 may be different according to, for example, the ejection amounts of the color inks to each position.

More specifically, in a case where the amount of the clear ink per unit area ejected to each position on the transfer medium 50 is defined as the clear ejection amount, it can be considered to differ the clear ejection amounts between the high gradation portion 312 (see FIG. 5(a) and FIG. 5(b)) where the amounts of the color inks ejected per unit area are larger, and the low gradation portion 316 where the amounts of the color inks ejected per unit area are less in the printing region. In this case, for example, it can be considered to differ the clear ejection amounts according to the amounts of the color inks ejected per unit area, to make the clear ejection amount in the low gradation portion 316 larger than the clear ejection amount in the high gradation portion 312. According to such configuration, for example, it is possible to appropriately eject the clear ink to the necessary portion while suppressing the amount of the clear ink used. Further, by reducing the clear ejection amount in the high gradation portion 312, for example, the total amount of the inks ejected to the same position can be prevented from excessively increasing.

The clear ejection amounts may be different between the medium gradation portion 314 and the low gradation portion 316, for example. In this case, for example, it can be considered to differ the clear ejection amounts according to the amounts of the color inks ejected per unit area, to make the clear ejection amount in the low gradation portion 316 larger than the clear ejection amount in the medium gradation portion 314. Further, for example, the clear ejection amounts may be different between the high gradation portion 312 and the medium gradation portion 314. In this case, for example, it can be considered to differ the clear ejection amounts according to the amounts of the color inks ejected per unit area, to make the clear ejection amount in the medium gradation portion 314 larger than the clear ejection amount in the high gradation portion 312. Further, for example, it can also be considered to make the clear ejection amount zero for the portions where the amounts of the color inks to be ejected are large, as in the high gradation portion 312. In this case, for example, the clear ink is not ejected to positions where the amounts of the color inks ejected per unit area are larger than a preset upper limit amount. According to such configuration, for example, the total amount of the inks ejected to the same positions can be more appropriately prevented from excessively increasing.

Further, as described above, the adhesiveness of the hot melt resin powder is enhanced in the low gradation portion 316, for example, by using the clear ink in this example. Then, in this case, for example, it can be considered that the transfer rate of the pigment that is the coloring material is increased by using the clear ink. In this case, a ratio of the coloring material moving from the transfer medium 50 to the transfer-receiving medium during the transfer is defined as the transfer rate. By ejecting the clear ink on at least a part of the low gradation portion 316 during the printing with the printing unit 14, for example, it can be considered that the transfer rate in at least the part of the low gradation portion 316 is higher than that in the case where the clear ink is not ejected. Further, attention is paid to the low gradation portion 316. For example, the printing unit 14 ejects the clear ink to at least a part of the low gradation portion 316. Accordingly, it can also be considered that the amount of the hot melt resin powder applied by the powder applying unit 16 (see FIG. 1(a) and FIG. 1(b)) to the positions to which the clear ink is ejected is larger than that in the case where the clear ink is not ejected.

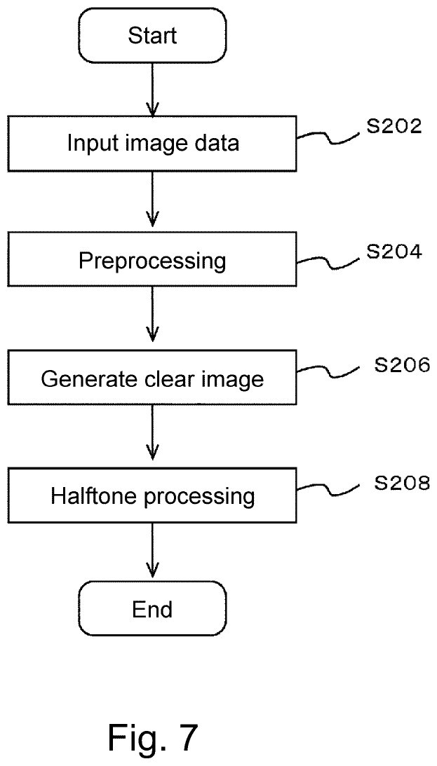

Further, as described above, in the case of performing the printing through the inkjet method, the ejection positions to which the color inks are ejected are determined, for example, by the halftone processing. Further, in the printing system 10 of this example, the print data preparation unit 12 (see FIG. 1(a) and FIG. 1(b)) performs the halftone processing and the like on the image data to generate the print data. Then, in this case, it can be considered to also determine the positions to which the clear ink is ejected in a series of operations executed in the print data preparation unit 12 to generate the print data. Further, in this case, the print data preparation unit 12 generates the print data by, for example, operations illustrated in FIG. 7.

FIG. 7 is a flowchart illustrating an example of operations of generating print data in the print data preparation unit 12. As described above, in this example, the print data preparation unit 12 generates the print data to be supplied to the printing unit 14 based on image data indicating the image to be printed on the transfer medium 50 in the printing unit 14. Then, in this operation, first, the image data is input to the print data preparation unit 12 (S202). As the image data, for example, it can be considered to use general known color image data indicating a color image. Further, as such image data, for example, an RGB image indicating the color image with red (R), green (G), and blue (B) as primary colors can be suitably used. It can be considered to input the image data from outside of the print data preparation unit 12 to the print data preparation unit 12 via, for example, a network, a storage medium, or the like. Further, as the color image indicated by the image data, it can be considered to use an image in which each gradation of basic colors (the primary colors) for the color expression is indicated by three or more gradations. More specifically, as the color image indicated by the image data, for example, an image, can be suitably used, that is expressed with a gradation of 8 bits or more for each color of RGB which is the basic color.

Further, after the image data is input, the print data preparation unit 12 performs preprocessing on the image data in accordance with the halftone processing to be performed later (S204). As this preprocessing, for example, it can be considered to perform resolution change processing, color conversion processing, separation processing, and the like. In this case, the resolution processing is, for example, processing of changing a resolution of the image according to the resolution of the printing executed by the printing unit 14. The color conversion processing is, for example, processing of converting the colors of the image in accordance with the colors of the inks used in the printing unit 14. In the color conversion processing, for example, it can be considered to convert the image indicated by the print data into an image expressing a color with a YMCK color system in accordance with the ink of each color of YMCK to be used for the printing. Further, the separation processing can be considered as, for example, processing of separating the image to be processed into images for each color of the ink used in the printing unit 14. The print data preparation unit 12 performs, for example, the separation processing on the image subjected to the resolution change processing and the color conversion processing, and generates a plurality of grayscale images each corresponding to each color of YMCK. In this case, the grayscale image corresponding to each color of YMCK can be considered to, for example, indicate the ejection amounts of the inks of that color ejected to each position of the image. As the grayscale image corresponding to each color of YMCK, for example, it can be considered to generate the grayscale image of the gradation of 8 bits or more.

Further, in this example, after performing the above preprocessing, the print data preparation unit 12 generates a clear image, which is an image used to determine the ejection positions for ejecting the clear ink (S206). In this case, the clear image can be considered as, for example, an image in which the ejection positions of the clear ink are determined by performing the halftone processing later. As the clear image, for example, it can be considered to generate the grayscale image. In this case, the clear image can be considered to, for example, indicate the ejection amount of the clear ink ejected each position of the image. As the clear image, for example, it can be considered to generate an image having the same number of gradations as the grayscale image corresponding to each color of YMCK generated in the separation processing. Further, more specifically, in this example, the print data preparation unit 12 calculates the total amount of the color inks ejected to each position of the image based on the grayscale image corresponding to each color of YMCK generated in the plate separation processing. Then, a value (a gradation) of each pixel of the clear image is determined based on the total amount. According to such configuration, for example, the ejection amount of the clear ink can be appropriately changed according to the amounts of the color inks ejected to each position of the image during the printing by the printing unit 14.

Further, after the clear image is generated, the print data preparation unit 12 performs the halftone processing on the grayscale image corresponding to each color of YMCK and the clear image (S208). The halftone processing can be considered as, for example, processing of reducing the number of the gradations of the image in accordance with the configuration of the printing unit 14. Further, the halftone processing can also be considered as, for example, processing (RIP processing) of generating a raster image for specifying ejection positions to which the inks of the colors corresponding to the grayscale image are ejected. In this example, the print data preparation unit 12 performs the halftone processing on the grayscale image corresponding to each color of YMCK to generate a raster image for specifying the ejection positions to which the ink of that color is ejected. Further, the print data preparation unit 12 performs the halftone processing on the clear image to generate a raster image for specifying the ejection positions to which the clear ink is ejected. The print data preparation unit 12 supplies data including these raster images to the printing unit 14 as the print data. According to such configuration, for example, the print data specifying the positions to which each of the color inks and the clear ink are ejected can be appropriately supplied to the printing unit 14.

Here, the operations of the print data preparation unit 12 can be performed identically or similarly to a known operation of generating the print data except for respects described above. Further, among the operations of the print data preparation unit 12 described above, operations other than the operations related to the clear image can be, for example, performed identically or similarly to the known operation of generating the print data. Further, as described above, in this example, the print data preparation unit 12 performs plate the separation processing based on the image data input to the print data preparation unit 12, and generates the grayscale image corresponding to each color of YMCK. Then, the clear image is generated based on the grayscale image corresponding to each color of YMCK generated by the separation processing. In this case, the clear image can also be considered to be generated based on, for example, the image data input to the print data preparation unit 12. Further, in this case, the operations of the print data preparation unit 12 can be considered to, for example, automatically determine the ejection positions of the clear ink based on the image data without the ejection positions of the clear ink directly specified. Further, the operations of the print data preparation unit 12 can also be considered to, for example, consider the amount of the clear ink to be ejected to each position of the image according to the gradations of the image indicated by the image data. Further, in a variation of the operation of the print data preparation unit 12, the data indicating the clear image may be supplied to the print data preparation unit 12 together with the image data, instead of the generation of the clear image in the print data preparation unit 12. Further, in this case, it can also be considered to supply the data directly indicating the ejection positions of the clear ink instead of the clear image to the print data preparation unit 12.

Next, an experiment performed by the inventors of this application in relation to the configurations described above will be described. As described above, in a case of the printing is performed by using only the color inks on the transfer medium, the transferability from the transfer medium to the transfer-receiving medium can be considered to be deteriorated in the low gradation region (the low gradation portion). Then, in this case, it can be considered that the graininess becomes conspicuous in the low gradation region in the image after being transferred to the transfer-receiving medium, and the like. On the other hand, in this example, the transferability of the image is enhanced and the graininess is reduced (improved) by supplementing the total amount (a liquid amount) of the inks by using the clear ink. Further, the inventors of this application have actually conducted the experiment and confirmed that the graininess is reduced by using the clear ink.

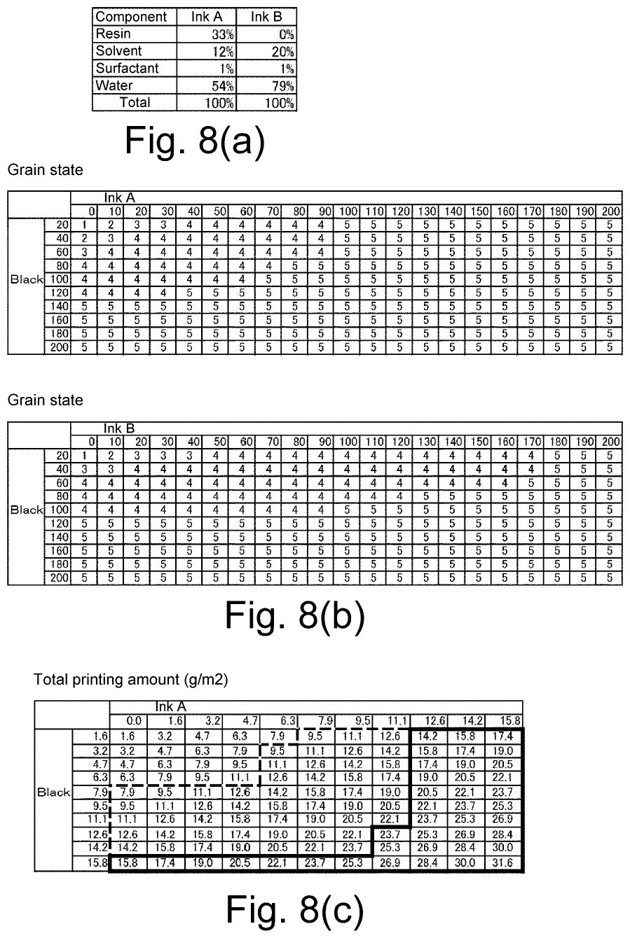

FIG. 8(a), FIG. 8(b) and FIG. 8(c) are views illustrating the experiment performed by the inventors of this application. FIG. 8(a) illustrates the composition of the clear ink used in the experiment. FIGS. 8(b) and 8(c) illustrate results of the experiment.

In this experiment, a known aqueous pigment ink was used as the color ink. Further, for convenience of the experiment, only a black ink having the graininess most conspicuous was used as the color ink. Then, as the clear ink, two types of inks illustrated as an ink A and an ink B in the drawings were used. In this case, the ink A can be considered as, for example, an ink without the pigment of the color ink, which is the coloring material. The ink B can be considered as, for example, an ink without the pigment that is the coloring material and a resin (a resin emulsion) corresponding to the binder resin of the color ink. In this case, the ink A and the ink B can be considered as substantially transparent inks. Further, the ink A can be considered as, for example, an ink that is transparent and contains the resin.

In this experiment, as illustrated in FIG. 8(b), amounts of the color ink and the clear ink ejected per unit area were variously changed to confirm the graininess on the transfer-receiving medium after the transfer. Further, the confirmed graininess was quantified with reference to a limit sample. In tables illustrated in FIG. 8(b), an upper table is results of the experiment using the ink A. A lower table shows results of the experiment using the Ink B. In the tables, the numerical values 0 to 200 shown in association with the ink A or the ink B indicate the ejection amount (the printing amount) of the clear ink (the ink A or the ink B) ejected per unit area. A numerical values 0 to 200 shown in association with the color ink (Black) indicates the ejection amount of the color ink ejected per unit area. Further, in these numerical values, 0 indicates a state where the corresponding ink is not ejected. Then, the ejection amount of the ink per unit area increases in proportion to the numerical values. Further, the graininess was evaluated by quantification in 5 stages of 1 to 5. In this case, a state where the graininess is most conspicuous corresponds to the numerical value 1, and a state where the graininess is most inconspicuous corresponds to the numerical value 5.

As can be understood from the tables illustrated in the drawing, in a case where the clear ink is not ejected, the graininess becomes more conspicuous if the ejection amount of the color ink is small. Then, in a case where the ejection amount of the color ink is small, the graininess can be reduced by increasing the ejection amount of the clear ink. Further, the graininess can be lightened regardless of whether or not the ink A or the ink B is used as the clear ink. Moreover, in a case of comparing the ink A with the ink B, the graininess can be lightened with a less ejection amount of the ink B. One of causes can be considered as that the ink A contains no resin, which makes the ink be more easily dried than the ink B. More specifically, for example, the hot melt resin powder can be considered to easily adhere to the ink containing a liquid component in a state before being completely dried. Therefore, in a case of using the ink B that is easily dried, it is likely to be necessary to eject a larger amount of the ink B than that of the ink A. Further, in the ink B, it can be considered that the adhesiveness of the resin is maintained even in a somewhat dry state. Therefore, in this respect as well, it can be considered that a less amount of the ink B can be used to lighten the graininess.

Further, from the results illustrated in FIG. 8(b), it can be seen that the graininess can be sufficiently lightened if a total ejection amount of the inks including the amount of the color ink and the amount of the clear ink exceeds a certain amount in a case of either using the ink A or the ink B. Accordingly, for example, it can be seen that the graininess does not occur even if the clear ink is not ejected to a portion where the ejection amount of the color ink is sufficiently large. Therefore, it can be understood from the results of this experiment that the ejection amount of the clear ink is preferably changed according to the ejection amount of the color ink.

Further, as described above, in this example, the transfer unevenness can also be prevented by using the clear ink. Then, the transfer unevenness can be appropriately prevented even in the case of using either the ink A or the ink B as the clear ink, similarly to the case described above with respect to the graininess. Further, more specifically, in a case of using the ink A, results of evaluation on the transfer unevenness are as shown in the table illustrated in FIG. 8(c). In the table illustrated in FIG. 8(c), the amount of each of the color ink and the clear ink is indicated by the ejection amount (the printing amount) per unit area. Then, in each cell of the table, the total ejection amount of the inks including the amount of the color ink and the amount of the clear ink is shown as a total printing amount per unit area. Further, in this table, a range surrounded by a thick solid line indicates a range in which the transfer unevenness as a problem did not occur. This range can be considered as, for example, a range in which the transfer unevenness is eliminated by ejecting the clear ink. Further, on an upper left side of the range surrounded by the thick solid line, a range surrounded by upper and left broken lines and lower and right thick solid lines is a range in which only slight transfer unevenness has occurred. This range can be considered as, for example, a range in which the transfer unevenness is greatly reduced by ejecting the clear ink. From the results illustrated in FIG. 8(c), it can be confirmed that the transferability is improved by using the clear ink in addition to the color ink in the case of using the ink A. Further, in this case, it can be confirmed that the transfer unevenness can be prevented by using the clear ink particularly in the low gradation region in which the transfer unevenness occurs if the clear ink is not used.

Note that, in the above experiment, as for the ejection of the color ink and the clear ink (the ink A or the ink B), the clear ink is ejected to the same position after the color ink was ejected to each position on the transfer medium and before the color ink at that position was completely dried. In this case, it can be considered that the color ink and the clear ink are under a condition of being simultaneously ejected on the transfer medium. Further, although not illustrated, an experiment corresponding to the table of FIG. 8(c) was also performed for the ink B. Further, according to this experiment, as also for the ink B, it has been confirmed that the transferability can be improved by using the clear ink in addition to the color ink, the transfer unevenness can be prevented by using the clear ink in the low gradation region in which the transfer unevenness occurs if the clear ink is not used, and the like.

Next, supplementary description and the like in relation to the configurations described above will be made. As described above, in this example, an ink for the textile printing containing the pigment as the coloring material (a textile printing pigment ink) can be suitably used as the color ink. Then, in this case, for example, an ink having a composition without the coloring material (the pigment) and the dispersant of the color ink can be suitably used as the clear ink. In this regard, if the color ink and the clear ink simultaneously used in the printing unit 14 are greatly different in ink characteristics (liquid properties), a difference is generated in a manner of aggregation or separation of the inks on the transfer medium. This can be considered to cause deterioration in image quality (an image quality defect) of the printing. On the other hand, in a case of using the clear ink as described above, the difference in characteristics between the color ink and the clear ink can be appropriately prevented from increasing. Accordingly, for example, high quality printing can be more appropriately performed.

Further, in this case, as described above, it can be considered to use the color ink containing the binder resin and use the ink containing the same resin as the binder resin in the color ink as the clear ink. Then, in this case, by containing the same resin as the binder resin, it can be considered as the state where the hot melt resin powder is likely to continuously adhere to the clear ink for a long time as compared with, for example, a case where the resin is not contained. Therefore, by using the clear ink containing the resin, for example, the hot melt resin powder can more reliably adhere to the position to which the clear ink is ejected. Further, as can be understood from the results or the like of the experiment described above with reference to FIG. 8(a), FIG. 8(b) and FIG. 8(c), the clear ink can also be the ink containing no resin. Also in this case, by using the clear ink, it is possible to lengthen the time until the ink dries to the state where the hot melt resin powder is less likely to adhere to the position to which the clear ink is ejected. Accordingly, for example, even in the case of using the clear ink containing no resin, the hot melt resin powder can appropriately adhere to the position to which the clear ink is ejected. Further, regarding a difference in composition between the color ink and the clear ink, it can be considered to adjust a decrease in the amount of the clear ink caused by removing some components (the coloring material and the like) from the color ink by appropriately changing an amount of the solvent. Further, it can also be considered to use a resin different from the binder resin in the color ink as the resin contained in the clear ink, and the like.

Further, as described above, in this example, it is possible to make the ink dots of the color inks in a state of being easily wet and spread, and increase the sizes of the dots by using the clear ink in addition to the color inks, for example. In this regard, the wet and the spreading of the color inks by the ejection of the clear ink can also be considered as, for example, the occurrence of smearing between the clear ink and the color inks. Further, this smearing can be considered as, for example, smearing that does not lower the quality of the printing, and the like, unlike inter-color smearing that occurs between different color inks. Further, the smearing between the clear ink and the color inks can also be considered to lower the graininess in the low gradation region by, for example, lowering densities of the colors and widening diameters of the dots as compared with a case of using the color inks alone.

Here, in order to lighten the graininess, for example, so-called light color inks may be used. In this case, for example, it can be considered to use the light color inks in which densities of the pigments are reduced in addition to the ink of each color of YMCK having a normal color density. However, in a case of performing the printing for a similar purpose to that of this example, it is necessary to use the light color inks for at least three colors of MCK to lighten the graininess by using the light color inks. Further, as a result, at least three inkjet heads need to be increased in the head unit 102 (see FIG. 1(a) and FIG. 1(b)) of the printing unit 14. Accordingly, problems such as compression of ink slots and an increase in size of the head unit 102 occur. Further, even if the light color inks are used, it can be considered that the hot melt resin powder is less likely to adhere in an extremely low gradation region in which the gradation is particularly low in the image, and the transfer unevenness occurs. On the other hand, in this example, it is possible to lighten the graininess while suppressing the increase in the number of the inkjet heads and the like by using a colorless clear ink that is not colored instead of the light color ink corresponding to a specific color ink. Further, in this case, it is also possible to appropriately prevent the occurrence of the transfer unevenness and the like by enable necessary amounts of the inks to be ejected even to the extremely low gradation region, and the like.

Further, in this example, lightening the graininess by using the clear ink can be considered to relate to, for example, the fact that the sizes of the color ink dots in the case where the clear ink is used can be made larger than the sizes of the color ink dots in the case where the clear ink is not used, as described above. Further, in this regard, in this example, it can be considered that the color inks and the clear ink are ejected to at least some of the ejection positions. Then, in this case, regarding the sizes of the color ink dots formed by spreading the impacted color inks on the transfer medium, the sizes of the dots formed in a case of ejecting both the color inks and the clear ink to the same ejection positions are defined as the clear use sizes. Further, the sizes of the dots formed in a case of ejecting only the color inks to the ejection positions are defined as the clear non-use sizes. In this case, in the printing unit 14, for example, it can be considered that the clear ink is ejected to at least some of the ejection positions to which the color inks are ejected in the low gradation portion of the image, to make the clear use size larger than the clear non-use size. According to such configuration, for example, the sizes of the ink dots formed with the color inks can be appropriately increased. Accordingly, for example, the graininess can be appropriately lightened.

Further, as described above, in this example, the hot melt resin powder is caused to more appropriately adhere to the low gradation portion or the like of the image by using the clear ink. In this regard, for example, in a case where the color inks are used without using the clear ink, it can be considered that the hot melt resin powder is particularly difficult to adhere at positions of isolated ink dots where other ink dots are not formed around. Therefore, in this example, for the clear ink, for example, it is preferable to increase the total amount of the inks near ejection positions of isolated color ink dots by ejecting the clear ink to the ejection positions of the isolated color ink dots or the ejection positions around. More specifically, in this example, the printing unit 14 ejects the color inks and the clear ink from the inkjet heads for the color inks and the clear ink to the ejection positions set according to the resolution of the printing. Then, in this case, it can be considered to eject the clear ink to continuously cover the region including the plurality of the ejection positions with the color inks and the clear ink in the printing unit 14. Continuously covering the range including the plurality of the ejection positions with the color inks and the clear ink can be considered as, for example, forming an arrangement of a plurality of ink dots in contact with each other on the transfer medium in the range including the plurality of the ejection positions.

Further, in this case, the ejection positions to which the color inks are ejected from the inkjet heads for the color inks are defined as colored ejection positions. Further, the colored ejection positions at which adjacent ejection positions are not the colored ejection positions are defined as isolated ejection positions. In this case, the low gradation portion in the image can be considered as, for example, a region including the isolated ejection positions. Then, in this case, the operation of the printing unit 14 can be considered as, for example, ejecting the clear ink from the inkjet head for the clear ink to at least some of the isolated ejection positions in the low gradation portion or the ejection positions near the isolated ejection positions. Further, in this case, the printing unit 14 performs the printing on the transfer medium to connect ranges including the plurality of the ejection positions including the isolated ejection positions by the color inks and the clear ink at least near the isolated ejection positions by ejecting the clear ink in this manner. According to such configuration, for example, the total amount of the inks ejected near the isolated ejection positions in the low gradation portion can be appropriately increased as compared with the case where the clear ink is not used. Accordingly, for example, the hot melt resin powder can be caused to more appropriately adhere near the isolated ejection positions. Further, in this case, the operation of ejecting the clear ink from the inkjet head for the clear ink to the ejection positions near the isolated ejection positions in the printing unit 14 can be considered as, for example, an operation of ejecting the clear ink from the inkjet head for the clear ink even to at least some of the ejection positions to which the color inks are not ejected. Further, in this case, for example, it can be considered to connect the plurality of color ink dots at different isolated ejection positions with the clear ink dots by ejecting the clear ink to the ejection positions between different isolated ejection positions. According to such configuration, for example, the hot melt resin powder can be caused to more appropriately adhere near the isolated ejection positions.

Further, as described above, in a case of performing the transfer by using the hot melt resin powder, it has been conventionally performed to use a white ink in addition to the color inks. However, application and use of the clear ink in this example are different from application and use of the white ink in a conventional configuration in various respects. More specifically, in a case of performing the color printing through the inkjet method, the white ink layer functions as a background that reflects light in the color expression (color reproduction) in the subtractive color mixing method when the white ink layer is formed by overlapping with the color ink layer. Further, in a case of performing the transfer by using the hot melt resin powder, the white ink layer also plays a major role as a concealing layer that conceals the base color (an underlayer color) of the transfer-receiving medium to which the image is transferred. Further, due to such characteristics of the white ink layer, the white ink layer is usually formed in a region including the entire image drawn with the color inks.

On the other hand, in a case of the clear ink used in this example, because of being a translucent ink, the ink usually does not function as a layer as the background that reflects the light or the layer that conceals the base color of the transfer-receiving medium, even if the clear ink layer is formed. Further, as can be understood from the above description and the like, in this example, a purpose of using the clear ink can be achieved even if the clear ink is ejected only on a part of the image drawn with the color inks. Further, unlike a case of forming the white ink layer functioning as the concealing layer, the ink used other than the color inks does not become excessively conspicuous on the transfer-receiving medium in the case of using the clear ink as in this example. Therefore, according to this example, for example, the high quality printing utilizing the texture or the like of the transfer-receiving medium can be appropriately performed in a case where a white or light color (bright color) fabric or the like is used as the transfer-receiving medium, as described above. Further, in this case, at least in these respects, the application and the use of the clear ink in this example can be said to be different from the application, the use, and the like of the white ink in the conventional configuration.

Further, as described above, in this example, the ejection amount of the clear ink to each position on the transfer medium may be different according to, for example, the ejection amounts of the color inks to each position. In this case, if the ejection amounts (the printing amounts) of the color inks to a region including each pixel in the transfer medium are equal to or less than a predetermined amount (X %), it can be considered to eject the clear ink to that region to supplement (replenish) insufficient amounts (liquid amounts) of the inks. Further, in this case, if the amounts of inks impacted per unit area exceeds a predetermined printing amount (liquid amount), it can be considered that the smearing tends to occur, and the hot melt resin powder adheres excessively, and a mark of the hot melt resin powder remains on the transfer-receiving medium. Therefore, it can be considered that the total ejection amount (printing amount) of the color inks and the clear ink to the region including each pixel in the transfer medium does not exceed another predetermined amount (Y %, Y>X). On the other hand, in the case of using the white ink, for example, if the ejection amount of the white ink to each position on the transfer medium is made different as described above, it can be considered that the white ink is impacted dot by dot between the color inks. Further, as a result, it can be considered that the colors in a part of the region are blurred and visually recognized in the image to be printed, and the like. In particular, in a case where the white ink is further ejected to the low gradation portion in the image, by covering some of the color ink dots with the white ink, it can also be considered that the colors in the low gradation portion where the colors are light becomes further lighter, the printing with intended colors is unable to be performed, and the like. Therefore, in this respect as well, the application and the use of the clear ink in this example can be said to be different from the application and the use of the white ink in the conventional configuration.

Further, as for the clear ink dots formed on the transfer medium by ejecting the clear ink to the transfer medium by the printing unit 14, for example, it can also be considered that the ink dots are preferably flattened and spread to make the hot melt resin powder more easily adhere. Then, in this case, it can also be considered to adjust the spread of the clear ink dots during the operation executed by the printing system 10. According to such configuration, for example, the sizes of the clear ink dots can be appropriately adjusted. Further, in this case, an operation of adjusting the spread of the clear ink dots can be considered as, for example, an operation of an adjustment stage of adjusting the spread of the clear ink dots formed on the transfer medium by the printing unit 14, and the like. The adjustment stage can also be considered as, for example, a stage of performing adjustment of the flattening (leveling adjustment) of the ink dots. Further, the operation of the adjustment stage can also be considered as, for example, an operation of a leveling stage for flattening the ink dots. The adjustment in the adjustment stage can be considered to be performed, for example, before a stage (the printing stage) of performing the printing on the transfer medium in the printing unit 14. Further, for example, the operation of the adjustment stage may be executed as necessary after the printing on the transfer medium is performed in the printing unit 14.

Further, in a case of executing the operation of the adjustment stage to adjust the spread of the ink dots, for example, the image is printed on the transfer medium by the printing unit 14 under a preset first printing condition. Then, based on the results of the printing, for example, it is determined whether or not the spread of the clear ink dots (a dot gain) is insufficient. Then, for example, in a case where it is determined that the spread of the dots is insufficient, a second condition different from the first printing condition is selected as a printing condition for causing the printing unit 14 to perform the printing at the printing stage. Further, in this case, for example, a condition in which the spread of the clear ink dots becomes larger is selected as the second condition. According to such configuration, for example, it is possible to appropriately determine whether or not it is necessary to change a printing condition for further flattening the ink dots, and appropriately change the printing condition as necessary. Accordingly, for example, the clear ink dots can be more appropriately flattened in the operation of printing on the transfer medium performed by the printing unit 14 later. Further, for example, in the operation performed later, it is possible to cause the hot melt resin powder to more appropriately adhere to the positions to which the clear ink is ejected.

Further, in this case, for example, it can be considered to use a printing condition for slowing a printing speed than the first printing condition as the second printing condition in the adjustment stage. Further, as the printing condition for slowing the printing speed, for example, it can be considered to use a condition for increasing a pass number of the printing. In this case, the pass number can be considered as, for example, the number of times of the main scan performed on the same position to be printed. Further, in a case of increasing the pass number, for example, it can be considered that a relative movement amounts of the inkjet heads during once sub scan decrease, and a transport speed of the medium becomes slow. Further, in this case, it can be considered to set the printing speed under the first printing condition to, for example, a normal printing speed (a standard printing speed) in the printing unit 14. Then, in this case, the printing speed under the second printing condition can also be considered as, for example, a printing speed slower than the normal printing speed. Further, selecting the second printing condition in the adjustment stage can also be considered as, for example, selecting a printing speed slower than a specific printing speed corresponding to the printing speed under the first printing condition.

Further, in order to increase the spread of the clear ink dots, for example, it can also be considered to perform the adjustment and the like from a viewpoint of a specific surface area by increasing sizes of droplets (ink droplets) ejected from the inkjet heads. Further, for example, it can also be considered to adjust the spread of the dots by changing a waveform (a drive waveform) of a drive signal for driving the ejection of the droplets from the inkjet heads. Therefore, the second printing condition may be different from the first printing condition, for example, from these viewpoints.

Further, for example, in a case of using the printing unit 14 configured to perform heating by using a heater during the printing, the printing conditions may be changed by changing a heating temperature of the heater. For example, in a case of using the ink that fixes to the transfer medium by the evaporation of the solvent as the clear ink, it can be considered to use the heater to heat the transfer medium. Then, in this case, for example, by setting the heating temperature of the heater under the second printing condition to be lower than the heating temperature under the first printing condition, it is possible to slow drying speeds of the inks, and further enlarge the spread of the clear ink dots. Further, in this case, for example, it can be considered to perform the adjustment as described above for a heating temperature of an after-heating unit that is a heater disposed on a downstream side lower than the inkjet heads in the conveyance direction, by using the printing unit 14 configured to perform the printing while conveying the medium. Further, in a case of using the after-heating unit in the printing unit 14, for example, the temperature may be adjusted by dividing the after-heating unit into a plurality of regions (for example, two to three regions). In this case, for example, it can be considered to divide the plurality of regions into regions closer to the inkjet heads in the conveyance direction and regions farther from the inkjet heads. Further, in this case, it can be considered to individually change the heating temperature of the after-heating unit for each of the regions. According to such configuration, for example, the spread of the ink dots can be adjusted in more detail. Further, as the heater in the printing unit 14, for example, it can also be considered to use a heater that heats the inkjet heads. In this case, for example, viscosities of the inks before being ejected can be changed by changing the heating temperature of the heater. Accordingly, for example, the viscosities of the inks ejected can be reduced by setting the heating temperature under the second printing condition to be higher than the heating temperature under the first printing condition, to make the inks in a state of more easily spreading on the transfer medium.

### INDUSTRIAL APPLICABILITY

This disclosure can be suitably used, for example, in the printing method.

To the claims:

1. A printing method for drawing an image on a transfer-receiving medium by transferring the image printed on a transfer medium to the transfer-receiving medium, the printing method comprising:
a printing stage of printing the image on the transfer medium with a printing device that performs printing through an inkjet method;
a hot melt resin adhering stage of causing hot melt resin powder, which is powder containing a resin softened through heating, to adhere to the transfer medium on which the image is printed; and
a transfer stage of transferring the image from the transfer medium to the transfer-receiving medium by causing a hot melt resin portion to adhere to the transfer-receiving medium, the hot melt resin portion being a resin portion formed by heating the transfer medium to which the hot melt resin powder adheres, and softening the hot melt resin powder through heating, wherein
the printing device includes:
a colored ink head that is an inkjet head ejecting a colored ink, which is an ink containing a coloring material showing a nonwhite color, and
a clear ink head that is an inkjet head ejecting a clear ink, which is a colorless and translucent ink, and
in the transfer medium, the clear ink is further ejected from the clear ink head to at least a part of a region to which the colored ink is ejected from the colored ink head in the printing stage.

2. The printing method as set forth in claim 1, wherein in the transfer stage, the image is transferred from the transfer medium to the transfer-receiving medium by moving at least a part of the coloring material adhering to the transfer medium to the transfer-receiving medium together with at least a part of the hot melt resin portion, and
in a case where a region to which the colored ink is ejected from the colored ink head in the transfer medium is defined as an image representing region,
a region to which an amount of the colored ink ejected per unit area is smaller than a preset reference amount is defined as a small amount of ink region, and
a ratio of the coloring material moving from the transfer medium to the transfer-receiving medium in the transfer stage is defined as a transfer rate,
by ejecting the clear ink to at least a part of the small amount of ink region in the image representing region with the printing device in the printing stage,
the transfer rate in at least the part of the small amount of ink region is higher than that in a case where the clear ink is not ejected.

3. The printing method as set forth in claim 2, wherein by ejecting the clear ink to at least the part of the small amount of ink region in the printing stage, an amount of the hot melt resin powder adhering to a position to which the clear ink is ejected in the hot melt resin adhering stage is made larger than that in the case where the clear ink is not ejected.

4. The printing method as set forth in claim 2, wherein in a case where a region to which the amount of the colored ink ejected per unit area is larger than a predetermined amount, which is larger than the reference amount in the image representing region is defined as a non-small amount of ink region, and
an amount of the clear ink per unit area ejected to each position on the transfer medium is defined as a clear ejection amount,
the clear ejection amount is differed according to the amount of the colored ink ejected per unit area, to make the clear ejection amount in the small amount of ink region larger than the clear ejection amount in the non-small amount of ink region in the printing stage.

5. The printing method as set forth in claim 4, wherein the clear ink is not ejected to a position where the amount of the colored ink ejected per unit area is larger than a preset upper limit amount in the printing stage.

6. The printing method as set forth in claim 2, wherein the printing device ejects the colored ink and the clear ink from the colored ink head and the clear ink head to ejection positions set according to a resolution of the printing, and
in a case where the ejection positions to which the colored ink is ejected from the colored ink head are defined as colored ejection positions, and the colored ejection positions where adjacent ejection positions are not the colored ejection positions are defined as isolated ejection positions,
the small amount of ink region is a region including the isolated ejection positions, and
in the printing stage, the printing is performed on the transfer medium to connect ranges including a plurality of the ejection positions including the isolated ejection positions by the colored ink and the clear ink at least near the isolated ejection positions, by ejecting the clear ink from the clear ink head to at least some of the isolated ejection positions in the small amount of ink region or the ejection positions around the isolated ejection positions.

7. The printing method as set forth in claim 1, further comprising an adjustment stage of adjusting spread of a dot of the clear ink formed on the transfer medium in the printing stage.

8. The printing method as set forth in claim 7, wherein in the adjustment stage, it is determined whether or not the spread of the dot of the clear ink is insufficient based on a result of printing the image on the transfer medium with the printing device under a preset first printing condition, and in a case where it is determined that the spread of the dot is insufficient, a second printing condition that is a condition different from the first printing condition and that the spread of the dot of the clear ink becomes larger is selected as a printing condition for causing the printing device to perform the printing in the printing stage.

9. A printing system that draws an image on a transfer-receiving medium by transferring the image printed on a transfer medium to the transfer-receiving medium, the printing system comprising:
a printing device that performs printing on the transfer medium through an inkjet method; and
a transfer unit that transfers the image from the transfer medium to the transfer-receiving medium, wherein
the transfer unit transfers the image from the transfer medium to the transfer-receiving medium by causing a hot melt resin portion to adhere to the transfer-receiving medium in a state where hot melt resin powder, which is powder containing a resin softened through heating, is caused to adhere to the transfer medium on which the image is printed, the hot melt resin portion being a resin portion formed by heating the transfer medium to which the hot melt resin powder adheres, and softening the hot melt resin powder through heating,
the printing device includes:
a colored ink head that is an inkjet head ejecting a colored ink, which is an ink containing a coloring material showing a nonwhite color, and
a clear ink head that is an inkjet head ejecting a clear ink, which is a colorless and translucent ink, and
in the transfer medium, the clear ink is further ejected from the clear ink head to at least a part of a region to which the colored ink is ejected from the colored ink head.

10. A printing device that performs printing on a transfer medium through an inkjet method in a printing system that draws an image on a transfer-receiving medium by transferring the image printed on the transfer medium to the transfer-receiving medium, the printing device comprising:
a colored ink head that is an inkjet head ejecting a colored ink, which is an ink containing a coloring material showing a nonwhite color; and
a clear ink head that is an inkjet head ejecting a clear ink, which is a colorless and translucent ink, wherein
transfer of the image from the transfer medium to the transfer-receiving medium is transfer of the image from the transfer medium to the transfer-receiving medium performed by causing a hot melt resin portion to adhere to the transfer-receiving medium in a state where hot melt resin powder, which is powder containing a resin softened through heating, is caused to adhere to the transfer medium on which the image is printed, the hot melt resin portion being a resin portion formed by heating the transfer medium to which the hot melt resin powder adheres, and softening the hot melt resin powder through heating, and
in the transfer medium, the clear ink is further ejected from the clear ink head to at least a part of a region to which the colored ink is ejected from the colored ink head, and a clear ejection amount, which is an amount of the clear ink per unit area ejected to each position on the transfer medium, is differed according to an amount of the colored ink ejected per unit area.

11. The printing method as set forth in claim 3, wherein in a case where a region to which the amount of the colored ink ejected per unit area is larger than a predetermined amount, which is larger than the reference amount in the image representing region is defined as a non-small amount of ink region, and
an amount of the clear ink per unit area ejected to each position on the transfer medium is defined as a clear ejection amount,
the clear ejection amount is differed according to the amount of the colored ink ejected per unit area, to make the clear ejection amount in the small amount of ink region larger than the clear ejection amount in the non-small amount of ink region in the printing stage.

12. The printing method as set forth in claim 11, wherein the clear ink is not ejected to a position where the amount of the colored ink ejected per unit area is larger than a preset upper limit amount in the printing stage.

13. The printing method as set forth in claim 3, wherein the printing device ejects the colored ink and the clear ink from the colored ink head and the clear ink head to ejection positions set according to a resolution of the printing, and
in a case where the ejection positions to which the colored ink is ejected from the colored ink head are defined as colored ejection positions, and the colored ejection positions where adjacent ejection positions are not the colored ejection positions are defined as isolated ejection positions,
the small amount of ink region is a region including the isolated ejection positions, and
in the printing stage, the printing is performed on the transfer medium to connect ranges including a plurality of the ejection positions including the isolated ejection positions by the colored ink and the clear ink at least near the isolated ejection positions, by ejecting the clear ink from the clear ink head to at least some of the isolated ejection positions in the small amount of ink region or the ejection positions around the isolated ejection positions.

14. The printing method as set forth in claim 4, wherein the printing device ejects the colored ink and the clear ink from the colored ink head and the clear ink head to ejection positions set according to a resolution of the printing, and
in a case where the ejection positions to which the colored ink is ejected from the colored ink head are defined as colored ejection positions, and the colored ejection positions where adjacent ejection positions are not the colored ejection positions are defined as isolated ejection positions,
the small amount of ink region is a region including the isolated ejection positions, and
in the printing stage, the printing is performed on the transfer medium to connect ranges including a plurality of the ejection positions including the isolated ejection positions by the colored ink and the clear ink at least near the isolated ejection positions, by ejecting the clear ink from the clear ink head to at least some of the isolated ejection positions in the small amount of ink region or the ejection positions around the isolated ejection positions.

15. The printing method as set forth in claim 5, wherein the printing device ejects the colored ink and the clear ink from the colored ink head and the clear ink head to ejection positions set according to a resolution of the printing, and
in a case where the ejection positions to which the colored ink is ejected from the colored ink head are defined as colored ejection positions, and the colored ejection positions where adjacent ejection positions are not the colored ejection positions are defined as isolated ejection positions,
the small amount of ink region is a region including the isolated ejection positions, and
in the printing stage, the printing is performed on the transfer medium to connect ranges including a plurality of the ejection positions including the isolated ejection positions by the colored ink and the clear ink at least near the isolated ejection positions, by ejecting the clear ink from the clear ink head to at least some of the isolated ejection positions in the small amount of ink region or the ejection positions around the isolated ejection positions.
